(19) United States
(12) Patent Application Publication
(10) Pub. No.: US 2015/0026060 A1
(43) Pub. Date: Jan. 22, 2015

(54) Financial Alert Management System Having A Mobile Interface

(71) Applicant: Double Check Solutions, LLC, Newport Beach, CA (US)

(72) Inventors: Mark Krietzman, Palos Verdes, CA (US); Joel Schwartz, Newport Beach, CA (US)

(21) Appl. No.: 14/325,329

(22) Filed: Jul. 7, 2014

Related U.S. Application Data
(63) Continuation-in-part of application No. PCT/US2013/068357, filed on Nov. 4, 2013.
Application No. PCT/US2013/068357 is a continuation-in-part of application No. PCT/US2013/068176, filed on Nov. 1, 2013.
Application No. PCT/US2013/068176 is a continuation-in-part of application No. PCT/US2013/068177, filed on Nov. 1, 2013.
Application No. PCT/US2013/068177 is a continuation-in-part of application No. PCT/US2013/068178, filed on Nov. 1, 2013.
(60) Provisional application No. 61/899,157, filed on Nov. 1, 2013.
(60) Provisional application No. 61/843,032, filed on Jul. 4, 2013.
(60) Provisional application No. 61/843,032, filed on Jul. 4, 2013.
(60) Provisional application No. 61/736,081, filed on Dec. 12, 2012.
(60) Provisional application No. 61/721,026, filed on Nov. 1, 2012.
(60) Provisional application No. 61/843,032, filed on Jul. 4, 2013.
(60) Provisional application No. 61/736,081, filed on Dec. 12, 2012.
(60) Provisional application No. 61/721,026, filed on Nov. 1, 2012.
(60) Provisional application No. 61/843,032, filed on Jul. 4, 2013.
(60) Provisional application No. 61/736,081, filed on Dec. 12, 2012.
(60) Provisional application No. 61/721,026, filed on Nov. 1, 2012.
(60) Provisional application No. 61/843,032, filed on Jul. 4, 2013.
(60) Provisional application No. 61/736,081, filed on Dec. 12, 2012.
(60) Provisional application No. 61/721,026, filed on Nov. 1, 2012.

(51) Int. Cl. G06Q 20/40

(52) U.S. Cl. CPC G06Q 20/40
USPC 705/44

(57) ABSTRACT

A Financial Alert Management System (“FAMS”) for reducing the occurrence of a non-payment event of a negotiable instrument listing a monetary amount at a first financial institution (“1^{st} FI”) is described. The FAMS includes a first communication module, a database, a timing module, a second communication module, a payment module, a mobile interface for financial alert system (“MIFAS”), and a controller in signal communication with the first communication module, the second communication module, the payment module, the timing module, and the database.

### CROSS-REFERENCE TO RELATED APPLICATIONS

This application claims the priority to United States (“U.S.”) Provisional Patent Application Ser. No. 61/843,032, titled “Financial And Credit Management,” filed on Jul. 4, 2013, to inventors Mark Krietzman and Joel Schwartz, the disclosure of which is incorporated by reference herein in its entirety.

Additionally, this application also claims the priority to U.S. Provisional Patent Application Ser. No. 61/899,157, titled “Risk and Escheat Management Method And System,” filed on Nov. 1, 2013, to inventors Mark Krietzman and Joel Schwartz, the disclosure of which is incorporated by reference herein in its entirety.

Moreover, this application is a continuation-in-part (“CIP”) of PCT Application Serial Number PCT/US2013/068176, titled “FINANCIAL ALERT MANAGEMENT SYSTEM,” filed on Nov. 1, 2013, to inventors Mark Krietzman and Joel Schwartz, the disclosure of which is incorporated by reference herein it its entirety.

Furthermore, this application is also a continuation-in-part (“CIP”) of PCT Application Serial Number PCT/US2013/068357, titled “DYNAMIC FRAUD ALERT SYSTEM,” filed on Nov. 4, 2013, to inventors Mark Krietzman and Joel Schwartz, the disclosure of which is incorporated by reference herein it its entirety.

Still furthermore, this application is also a continuation-in-part (“CIP”) of PCT Application Serial Number PCT/US2013/068177, titled “FINANCIAL ALERT MANAGEMENT SYSTEM,” filed on Nov. 2, 2013, to inventors Mark Krietzman and Joel Schwartz, the disclosure of which is incorporated by reference herein it its entirety.

Still furthermore, this application is also a continuation-in-part (“CIP”) of PCT Application Serial Number PCT/US2013/068178, titled “FINANCIAL MEASURE OF GOOD ACTION METRIC SYSTEM,” filed on Nov. 2, 2013, to inventors Mark Krietzman and Joel Schwartz, the disclosure of which is incorporated by reference herein it its entirety.

Still furthermore, this application claims the priority to U.S. Provisional Patent Application Ser. No. 61/721,026, titled “Payment Alerts And Reminders For Accounts With Imbalances,” filed on Nov. 1, 2012, to inventors Mark Krietzman and Joel Schwartz, through PCT Application Serial Number PCT/US2013/068176, which claimed priority to U.S. Provisional Patent Application Ser. No. 61/721,026, the disclosure of which is incorporated by reference herein in its entirety.

Still furthermore, this application also claims the priority to U.S. Provisional Patent Application Ser. No. 61/736,081, titled “Reminders Alert Provider For Bank Accounts With Imbalances,” filed on Dec. 12, 2012, to inventors Mark Krietzman and Joel Schwartz, through PCT Application Serial Number PCT/US2013/068176, which claimed priority to U.S. Provisional Patent Application Ser. No. 61/736,081, the disclosure of which is incorporated by reference herein in its entirety.

### BACKGROUND OF THE INVENTION

1. Field of the Invention

The present invention relates generally to the financial service industry and, more particularly, to a system and method for dealing with situations that generate non-sufficient funds (“NSF”) conditions in financial accounts.

2. Related Art

At present, the economy of today's modern society is very dependent on its financial system. This financial system includes numerous financial institutions that broadly speaking may be divided into three major types that include depositary institutions, contractual institutions, and investment institutions. Typically, depository institutions are deposit-taking financial institutions that accept and manage deposits and make loans. Examples of these deposit-taking financial institutions include banks, savings and loan, credit unions, trust companies, and mortgage loan companies. Examples of contractual institutions are pension funds. Furthermore, examples of investment institutions are investment banks, underwriters, and brokerage firms. Generally, all of these financial institutions are regulated by the national governments having jurisdiction to which these financial institutions are subject to. In the case of the United States (“U.S.”), these types of financial institutions are regulated by various agencies of the U.S. Federal government and at times the individual State governments having jurisdiction of these financial institutions.

At present, the U.S. payment system is the largest in the world. Each day, millions of transactions, valued in the trillions of dollars, are conducted between sellers and purchasers of goods, services, or financial assets. Most of the payments underlying those transactions flow between depository institutions, a large number of which maintain accounts with the Federal Reserve Banks of the Federal Reserve System (also known as the “Federal Reserve”) of the U.S. As such, the Federal Reserve performs an important role as an intermediary in clearing and settling interbank payments. Typically, depository institutions settle payment transactions efficiently by debiting the accounts of the depository institutions making payments and by crediting the accounts of depository institutions receiving payments.

Generally, the Federal Reserve utilizes three main payment and settlement systems. The first is Fedwire Funds Service (known generally as “Fedwire”), the second is the Automated Clearing House (“ACH”), and the third is other Check clearing services (including Check 21). Usually, participating financial institutions utilize Fedwire for large-value, time-critically payments, such as: payments to settle interbank purchase and sales of federal funds; to purchase, sell, or finance securities transactions; to disburse or repay large loans; and to settle real estate transactions. The U.S. Department of the Treasury and other federal agencies or government-sponsored enterprises also utilize Fedwire to disburse and collect funds. For other types of payments, typically, ACH is utilized.

ACH is an electronic payment system that was originally developed jointly by the private sector and the Federal Reserve in the 1970s as a more-efficient alternative to payments by checks. Since then, the ACH has evolved into a nationwide mechanism that processes credit and debit transfers electronically. ACH credit transfers are used to make direct deposit payroll payments and corporate payments to vendors. ACH debit transfers are used by consumers to authorize the payment of insurance premiums, mortgages, loans, and other bills from their account. The ACH is also used by businesses to concentrate funds at a primary bank and to make payments to other businesses. An example of an ACH is the Electronic Payments Network (“EPN”) that provides functions similar to those provided by the Federal Reserve Banks and is the only private-sector ACH operator in the U.S.

Check 21 services are based on 12 U.S.C. Chapter 50 (§§5001-5018), the Check Clearing for the 21st Century Act (known as the “Check 21 Act”). The Check 21 Act allows the recipient (i.e., a payee) of an original paper check to create a digital version of the original check, a process known as check truncation, in an electronic format called a “substitute check,” thereby eliminating the need for further handling of the physical original check. Once a check is truncated, businesses and banks can work with either the digital image or a print reproduction of the digitized images. Digitized images can be exchanged between member banks, savings and loans, credit unions, servicers, clearinghouses, and the Federal Reserve Bank. It is appreciated by those skilled in the art that Check 21 services are not subject to ACH rules.

As a result of the Check 21 Act, a new bank treasury management product has been created that is known as “remote deposit.” In general, remote deposit allows a depositing customer the ability to capture the front and rear images of his/her check along with the respective magnetic ink character recognition (“MICR”) data of the check which typically includes the routing number of the financial institution issuing the check, the account number at the financial institution to which the check may be drawn from, and the check number of the check. This data may then be uploaded (by the depositing customer) to a depositing financial institution of the depositing customer, at which time the account of the depositing customer is then credited with the monetary amount listed on the check. With remote deposit, the old need for merchants and other large depositors to travel to the bank (or branch) to physically make a deposit is gone.

In addition to remote deposit, other electronic depositing services are now available through the ACH.

As a result of all of these electronic payment services, it is possible that a negotiable instrument (such as, for example, a check or an ACH withdrawal) may be generated that for a number of different reasons may not be honored by the financial institution associated with the account on which the negotiable instrument is drawn, i.e., the Payor bank. One reason might be that there are insufficient funds available in the account on which the negotiable instrument is attempting to be drawn. This is generally termed non-sufficient funds (“NSF”). Similarly, a situation where the funds deposited in the account have not yet cleared (i.e., making the funds unavailable) is generally termed uncollected funds (“UCF”). It is appreciated by those skilled in the art that whether the funds are NSF or UCF, unless specified as differently herein, the term NSF will be utilized for both instances. The reasons for the insufficient (i.e., inadequate) funds may because the account is overdrawn (i.e., an overdraft has occurred and money has been withdrawn from the account in an amount that has caused the available balance in the account to be less than zero) or because the amount listed on the negotiable instrument exceeds the available balance in the account even though that balance is an amount greater than zero but less than the amount listed on the negotiable instrument. Since checks, substitute checks, and ACH withdrawals are negotiable instruments that are not preauthorized withdrawals (such as ATM withdrawals and debit or check card withdrawals), the financial institution associated with the account may refuse to pay the negotiable instrument (in this example a non-preauthorized withdrawal request) and return the negotiable instrument as unpaid.

Unfortunately, even though the Payor's financial institution may refuse to honor a negotiable instrument if it is drawn against insufficient or unavailable funds, the reality is that if the bearer of the negotiable instrument (i.e., the Payee) does not physically come to the Payor's financial institutions to cash the negotiable instrument but, instead, deposits the check into his/her account (i.e., Payee account) at a different financial institution, then via overnight processing the Payor's financial institution may automatically pay/credit the amount listed on the negotiable instrument to Payee's account and then, only after Payor's financial institution performs a clearing process will Payor's financial institution learn that the negotiable instrument actually caused an NSF occurrence (also known as an NSF event).

On the Payor side of the equation, Payor's financial institution will generate an NSF notification and have to issue a Non-paid deposit notice (“NPD notice”). Once the Payee's financial institution receives the NPD notice the Payee's financial institution will have to repay the amount received less a charge for the risk. Further, the first financial institution (corresponding to the person generating the negotiable instrument—i.e., the Payor) will not honor the negotiable instrument and will send the Payor a NSF notification via first class mail and additionally charge the Payor a fee for generating a “bad” negotiable instrument.

On the Payee side of the equation, the Payee generally will be charged a fee from his/her financial intuition for the NSF instrument. Additionally, the Payee may have written negotiable instruments against the Payor's negotiable instrument thereby creating a snowball effect of bad instruments.

At this point, the Payee is left with the sole responsibility of collecting from the Payor the outstanding monetary amount listed on the negotiable instrument as well as any associated penalties, costs and fees. This may lead the Payee to bring legal action against the Payor. Moreover, the Payee's financial institution may also report the Payor to a database for bad check writers such as, for example, Check Connection, TeleCheck, Shared Check Authorization Network (“SCAN”) or ChexSystems. Finally, knowingly passing a “bad check” is a crime in most States with a range of criminal penalties.

Each business day every depositary financial institution generates a NSF list following reconciling accounts with the corresponding negotiable instruments (physical, ACH and electronic checks) received the previous business day. The list contains the NSF occurrence. Typically, for each NSF occurrence, the NSF list includes information about the corresponding account and the corresponding account holder. Traditionally, a manager of a given depositary financial institution would review the NSF list. In a very limited number of subjective situations, the manager had the discretion to have his/her financial institution pay a negotiable instrument (this is the exception traditionally linked to the manager knowing or having a special relationship with the Payor who wrote the negotiable instrument) to give that customer a chance to cover such an item. Typically this service was free and considered a benefit offered by some financial institutions to a very limited number of people. Unfortunately, this ad-hoc coverage was fully discretionary and the rare exception to the rule of returning the item unpaid.

In order to better understand the above discussed problem, the problem is illustrated in FIG. 1. In FIG. 1, a block diagram of an example of an implementation of a known way of paying with a negotiable instrument 100 between two people is shown. In this example, the first person is a Payor 102 and the second person is a Payee 104. The Payor 102 has a Payor account 106 at a first financial institution (“1st FI”) 108 and the Payee 104 has a Payee account 110 at a second financial institution (“2nd FI”) 112. In this example, the 1st FI 108 and 2nd FI 112 are in signal communication with each other over a signal path 114 which may include any known communication network 116. The communication network 116 may be a computer network such as, for example, the Internet, or a proprietary secure network. The signal path 114 between the 1st FI 108 and 2nd FI 112 may include a first computer server 118 (at the 1st FI 108) and a second computer server 120 (at the 2nd FI 112). It is appreciated that the Payor 102, Payee 104, or both, may be optionally business entities instead of individuals. Additionally, the Payor account 106, Payee account 110, or both, may be checking accounts. Moreover, it is appreciated that the communication network 116 may be in signal communication with a regional Federal Reserve Bank 117.

In an example of operation, the Payer 102 generates 122 the negotiable instrument 100 (such as, for example, a check, substitute check, or automated clearing house (“ACH”) payment) that lists a monetary amount 124 and passes 126 it to the Payee 104 either physically or electronically. In this example, the negotiable instrument 100 is drawn on the Payor account 106 such that the Payor 102 is a “Drawer” of the Payor account 106 and the 1st FI 108 is a “Drawee” because the 1st FI 108 is where the negotiable instrument 100 can be presented for payment from the Payor account 106. Once received by the Payee 104, the Payee 104 then deposits 128 the negotiable instrument 100 into the Payee account 110 either physically or utilizing remote deposit under the Check 21 Act. Once the negotiable instrument 100 is deposited into the Payee account 110, the 2nd FI 112 may present 130 the negotiable instrument 100 (via for example, a substitute check) to the 1st FI 108 for payment via the signal path 114 that includes the communication network 116. In response, the 1st FI 108 sends a payment 132 for the monetary amount listed 124 on the negotiable instrument 100 via a computerized system (such as, for example, first computer server 118) utilizing the proper software. The 1st FI 108 may utilize a Check 21 system or other interbank transaction system.

In this example, once the 1st FI 108 has sent the payment 132 to the 2nd FI 112, the 1st FI 108 then withdraws the funds from the Payor account 106 and determines if there are sufficient funds available in the Payor account 106 to pay the listed monetary amount 124 of the negotiable instrument 100. If the funds are available in the Payor account 106, the listed monetary amount 124 of the negotiable instrument 100 is withdrawn from the Payor account 106 to satisfy the payment 132 made by the 1st FI 108. If, instead, the 1st FI 108 determines that there are insufficient funds in the Payor account 106 to pay the listed monetary amount 124 of the negotiable instrument 100, the clearing process designates the negotiable instrument 100 as causing an NSF occurrence and then places it as an NSF item on an NSF list that will be generated that day by the 1st FI 108. In this example, the clearing process may be performed by a computer system such as, for example, a reconciliation system 134. The reconciliation system 134 may be optionally part of the first server 118 or another independent computer system of the 1st FI 108. The reconciliation system 134 may include software that includes rules and decisions engines/modules to reconcile the amount paid on behalf of the Payor 102 with the funds available from the Payor account 106. The reconciliation system 134 has access to the 1st FI 108 customer lists and corresponding accounts such that it may generate a daily NSF list 136 that includes all NSF occurrences with the corresponding negotiable instruments that caused the NSF occurrences, the corresponding accounts of the negotiable instruments, and the corresponding customer information of the accounts. This NSF list 136 may then be received and reviewed by a manager 138 of the 1st FI 108.

In some exceptional cases, the manager 138 notices the Payor 102 is listed on the NSF list 136 as a result of negotiable instrument 100 causing an NSF occurrence and the manager 138 subjectively considers the Payor 102 an important or favorite customer of the 1st FI 108. The manager 138, in some instances, may have the discretion to have the 1st FI 108 pay the negotiable instrument 100 and because the negotiable instrument is then marked “pay,” an NSF notification 139 is not sent to the Payor 102 and the 2nd FI 112 is not notified, with a NPD notice 140, that the negotiable instrument was not paid.

In another example, as another exceptional instance the manager 138, or other 1st FI 108 representative, may notify 142 the Payor 102 of the need to cover the negotiable instrument 100 on the NSF list. In order to cover the instrument 100, the Payor must physically locate the manager (or his/her designee), pay cash and the manager (or his/her designee) must locate the NSF record in the 1st FI's 108 system and manually mark the negotiable instrument 100 as “pay.”

If the Payor 102 does not deposit the funds 144 within the time allowed by the 1st FI 108, the 1st FI will notify the 2nd FI 112 with a NPD notice 140 that the negotiable instrument 100 is not paid. Or in those cases when the 1st FI 108 automatically paid the 2nd FI 112 before reconciling the negotiable instruments, the 1st FI 108 must demand repayment of the funds previously paid to the 2nd FI 112 by the 1st FI 108 in relationship to the listed monetary amount 124 electronically paid for the negotiable instrument 100. The 2nd FI 112 will return the payment 146 to the 1st FI 108, usually, less a charge back or cost for the transaction. The 2nd FI 112 may then optionally charge the Payee 104 a returned payment fee 148 which will be withdrawn from the Payee account 110. The Payee 104 is then again left to enforce the payment of the listed monetary amount owed by the Payor 102 by himself/herself. As stated above, this could result in possible undesirable legal, personal financial, personal reputation, and criminal issues for the Payor 102.

Attempts to solve these problems have included overdraft protection plans, linked account protection plans, and methods that notify the Payor of an overdraft condition with an associated time to cure the overdraft condition. Unfortunately, these attempted solutions do not always protect the Payor when an NSF occurs. Providing a means to reduce the cost of overdraft fees to a customer who has opted into an overdraft program is a distinct banking area wherein the customer is utilizing overdraft protection (i.e., a loan) to cover a debt. As an example, while overdraft protection plans typically can cover checks (up to an specific amount), ATM withdrawals, debit or check card withdrawals, electronic transfers, and the like, they usually require that the Payor is capable of financially qualifying for the plans, which are interest bearing loans from the financial institution. As such, the Payor may be denied qualifying for an overdraft protection plan if the credit rating or other financial situation of the Payor does not meet the minimums required by the financial institution. Similarly, the Payor may not be in financial situation where he/she is capable of having multiple accounts at the same financial institution that may be linked so as to be part of a linked account protection plan. Finally, there a numerous problems associated with known systems or methods that allow the Payor to cure an overdraft condition within a specified time period.

As an example, a system and method for allowing a Payor to cure an overdraft condition within a specified time period is described in U.S. Pat. No. 8,364,581, titled “System and Method For Providing Time To Cure Negative Balances In Financial Accounts While Encouraging Rapid Curing Of Those Balances To A Positive Net Position,” issued to Schamer et al. Jan. 29, 2013, herein referred to as “the '581 patent.” Generally, according to the '581 patent (in column 2, lines 47 to 60), a computer-implemented method is disclosed (with emphasis added)
for performing financial services comprising the step of determining an account balance for a financial account of a customer. If the account balance is negative, it is determined after a predetermined period of time and/or a predetermined end time or cut-off date or time, whether the negative balance of the financial account was cured. An overdraft fee is assessed to the financial account if the negative balance of the financial account was not cured during the predetermined period of time.

The '581 patent (in column 3, lines 6 to 17) also discloses (with emphasis added)
a computer-implemented method for performing financial services comprising the step of determining an account balance for a financial account of a customer. If the account balance is negative, it is determined after a predetermined period of time and/or a predetermined end time or cut-off date or time, whether the negative balance of the financial account was cured. Any assessed overdraft fee for the negative balance is rebated to the financial account if the negative balance of the financial account was cured during the predetermined period of time. The predetermined period of time preferably extends at least until the next calendar day but can extend at least until the next business day.

Unfortunately, the '581 patent only describes a situation where the account of the Payor is overdrawn (i.e., described earlier as an overdraft). As such, the '581 patent describes a situation where the account of the Payor is utilizing an overdraft loan vehicle to cover a debt. As mentioned earlier, a negotiable instrument that is a non-preauthorized withdrawal (i.e. a check, substitute check, or ACH withdrawal) will not cause an overdraft because most financial institutions will not honor payment of these types of negotiable instruments when there are insufficient funds in the account associated with the negotiable instrument. As such, these types of negotiable instruments will not cause the account associated with the negotiable instrument to become negative as described in the '581 patent.

Specifically, the '581 patent describes situations whereby the account holder has opted into an overdraft protection plan and is not concerned with items returned non-paid as noted in the following discussion of the background section of the '581 patent (with emphasis added).

An overdraft occurs when a withdrawal from a bank or other financial institution account exceeds the available funds in the account. That is, the account has insufficient funds to cover the withdrawal. In the case of withdrawals such as checks or ACH withdrawals, the account provider can return the withdrawal request as unpaid. In the case of preauthorized withdrawals such as ATM withdrawals and debit or check card withdrawals, however, the account provider must pay the withdrawal request when presented, even if the withdrawal causes an overdraft. The account holder must then seek additional funds from the account holder to cover the overdraft and can charge the account holder overdraft fees as a penalty. (Column 1, lines 37 through 48)

Traditionally, the manager of a bank or other financial institution would look at a list of overdrafts each day. If the manager saw that a favored customer had incurred an overdraft, they had the discretion to pay the overdraft for the customer. Banks traditionally did not charge for this ad-hoc coverage but it was fully discretionary. This traditional ad-hoc coverage has practically disappeared. (Column 1, lines 49 through 55)

Account holders today can obtain overdraft protection plans. An overdraft protection plan is a contractual relationship in which the account provider promises to pay overdrafts up to a certain dollar limit. These overdraft lines of credit are typically loans and account holders typically charge a nominal fee per overdraft and also charge interest on the outstanding balance. Some account providers charge a small monthly fee regardless of whether the line of credit is used. Overdraft protection can cover checks, ATM Withdrawals, debit or check card withdrawals, electronic transfers, and the like. In the case of non-preauthorized items such as checks or ACH withdrawals, the overdraft protection allows for these withdrawals to be paid as opposed to being returned unpaid or “bouncing”. However, not all account holders qualify for such loans. (Column 1, line 56 through Column 2, line 3)

From this discussion, it is seen that the '581 patent recognizes that a NSF occurrence may occur that may cause an overdraft. However, generally an overdraft is a type of NSF occurrence but not all NSF occurrences are overdrafts because a NSF occurrence may occur when a withdrawal is attempted on an account that has insufficient funds to cover the withdrawal. Specifically, the '581 patent states that if this attempted withdrawal was the result of a check (also assumes a substitute check under the Check 21 Act) or ACH withdrawal, the type of withdrawal would be a non-preauthorized withdrawal (because it is not an ATM withdrawal, debit, or check card withdrawal) which “the account provider can return . . . as unpaid.” As such, the '581 patent specifically addresses the situation where the account holder (i.e., the Payor) has caused, either directly or indirectly, an overdraft on the account which shows up on a “list of overdrafts each day.” It does not, however, address the situation where an NSF occurrence is not an overdraft, which may be a larger problem than when the Payor causes an overdraft because checks, substitute checks, or ACH withdrawals may not be honored by the financial institution even though there are funds available in the associated account, which while being insufficient to pay the withdrawal request are still there and do not cause an overdraft.

An additional problem not addressed by the '581 patent is the form of payment that needs to be made by the Payor to “cure” the “negative balance of the financial account,” which is typically cash or cashier's check. Many times the Payor will not be able to make a payment that cures the overdraft, or cures an NSF occurrence, unless he/she physically goes to the financial institution. The reason for this is that financial institutions typically generate NSF lists and overdraft lists automatically via a computerized system (such as the reconciliation system 134 shown in FIG. 1) that must be reviewed by the manager. If, for example, the Payor deposits funds online or physically pays a teller at the financial institution, the deposited funds will be added to the account but unless the Payor locates a person with the authority to alter an NSF list and that authorized person identifies the NSF item corresponding to the Payor, the deposited funds will not be applied to the NSF or overdraft lists because they have already been run. Rather, those funds will simply be deposited to the account and increase its balance. As such, the Payor will still be listed as having an NSF occurrence and the associated negotiable instrument that caused the NSF occurrence will still be not honored and will be returned as having insufficient funds even though in, after the fact, the account was funded.

As such, there is a need for a system and method that improves the processing of NSF occurrences so as to address the above described problems.

### SUMMARY

A Financial Alert Management System (“FAMS”) for reducing the occurrence of a non-payment event of a negotiable instrument listing a monetary amount at a first financial institution (“1^{st} FI”) is described. The negotiable instrument was generated by a Payor having a Payor account at the 1^{st} FI and the negotiable instrument has caused a non-sufficient funds (“NSF”) occurrence because the monetary amount of the negotiable instrument exceeds an available funds amount in the Payor account. In this example, an overdraft, which is actually drawn on the Payor account, is an NSF occurrence that results in the available funds amount becoming negative. Additionally, the 1^{st} FI has produced an NSF list that includes the NSF occurrence as an NSF item within the NSF list and the 1^{st} FI has produced a Payor contact list that includes contact information for the Payor. Moreover, the 1^{st} FI determines an FI predetermined time period for receiving funds to cover the NSF occurrence before the non-payment event occurs where the 1^{st} FI refuses to pay the negotiable instrument. The FAMS includes a first communication module, a database, a timing module, a second communication module, a payment module, a mobile interface for financial alert system (“MIFAS”), and a controller in signal communication with the first communication module, the second communication module, the payment module, the timing module, and the database. The controller is configured to control the operation of the FAMS and the first communication module is configured to receive the NSF list, the Payor contact list, and the FI predetermined time period from the 1^{st} FI. Additionally, the database is configured to store the NSF items from the NSF list and the contact information for the Payor from the Payor contact list and the stored NSF items are not overdrafts. Moreover, the timing module is configured to generate a FAMS predetermined time period based on the FI predetermined time period and the second communication module is configured to attempt communication with the Payor based on the contact information for the Payor and, if successful, communicate to the Payor the NSF occurrence, the need to pay at least the amount necessary to cure the NSF occurrence, and the FAMS predetermined time period. Furthermore, the payment module is configured to receive a payment from the Payor and the first communication module is further configured to send a payment notice to the 1^{st} FI such that the 1^{st} FI does not refuse to pay the negotiable instrument. Still furthermore, the MIFAS is in signal communication with a mobile device.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a block diagram of an example of an implementation of a known way of paying with a negotiable instrument between two people.

FIG. 2 is a block diagram of an example of an implementation of a system for an improved way of paying with a negotiable instrument between two people and utilizing a Financial Alert Management System (“FAMS”) in accordance with the present invention.

FIG. 3 is a block diagram of an example of an implementation of a third-party FAMS that reduces the effects of an NSF occurrence caused by a negotiable instrument that is utilized by a Payor to pay a Payee in accordance with the present invention.

FIG. 4 is a table that includes an example of an implementation of tabular data regarding the NSF items and contact information for the Payors corresponding to the NSF items in accordance with the present invention.

FIG. 5 is a table that includes an example of an implementation of tabular data that includes contact information related to a customer shown in FIG. 4 in accordance with the invention.

FIG. 6 is a block diagram of an example of an implementation of the FAMS in signal communication with a plurality of FIs in accordance with the present invention.

FIG. 7 is a flowchart of an example of an implementation of a method for reducing the occurrence of a non-payment event (by a 1st FI) of a negotiable instrument listing a monetary amount (where the negotiable instrument was generated by a Payor having a Payor account at the 1st FI) with the FAMS described in FIGS. 2, 3, and 6 in accordance with the present invention.

FIG. 8 is a block diagram of an example of another implementation of a FAMS that reduces the effects of an NSF occurrence caused by a negotiable instrument that is utilized by a Payor to pay a Payee where the FAMS is part of an FT in accordance with the present invention.

FIG. 9 is a flowchart of an example of an implementation of a method for reducing the occurrence of a non-payment event (by a 1^{st} FI) of a negotiable instrument listing a monetary amount (where the negotiable instrument was generated by a Payor having a Payor account at the 1^{st} FI) with the FAMS described in FIG. 8 in accordance with the present invention.

FIG. 10 is three sub-flowcharts of some of the steps shown in FIG. 9 in accordance with the invention.

FIG. 11 is a block diagram of an example of an implementation of a DFAS 800 in accordance with the present invention.

FIG. 12 is a flowchart of an example of an implementation of a method for receiving RTIs from customers of the DFAS and utilizing the information available to the DFAS to determine if there is any potential fraud in accordance with the present invention.

FIG. 13 is an illustration of a time line as a comparison of DFAS pro-active fraud watch to traditional methods and systems.

FIG. 14 is a flowchart of an example of an implementation of a method for monitoring NSF items (from different FIs against the same Payor) that are provided to the FAMS with the DFAS and utilizing the information available to the DFAS to determine if there is any potential fraud.

FIG. 15 is a block diagram of an example of implementation of a MOGA within a FAMS in accordance with the present invention.

FIG. 16 is a pair of tables showing a comparison of MOGA generated metric scores for two Payors based on multiple NSF occurrences in accordance with the present invention.

FIG. 17 is a flowchart of an example of an implementation of a method of generating MOGA generated metric scores in accordance with the present invention.

FIG. 18 is a front view of a display screen view of a mobile device utilizing a mobile application for communicating with the FAMS in accordance with the present invention.

FIG. 19 is a front view of a mobile device showing another display screen view in accordance with the present invention.

FIG. 20 is a front view of a mobile device showing a login screen in accordance with the present invention.

FIG. 21 is a front view of a mobile device showing an events screen in accordance with the present invention.

FIG. 22 is a front view of a mobile device showing a payment options screen in accordance with the present invention.

FIG. 23 is a flowchart of an example of an implementation of a process that describes a potential offer for an overdraft account (“ODA”) from the FI of the Payor to the Payor to pay an NSF event(s).

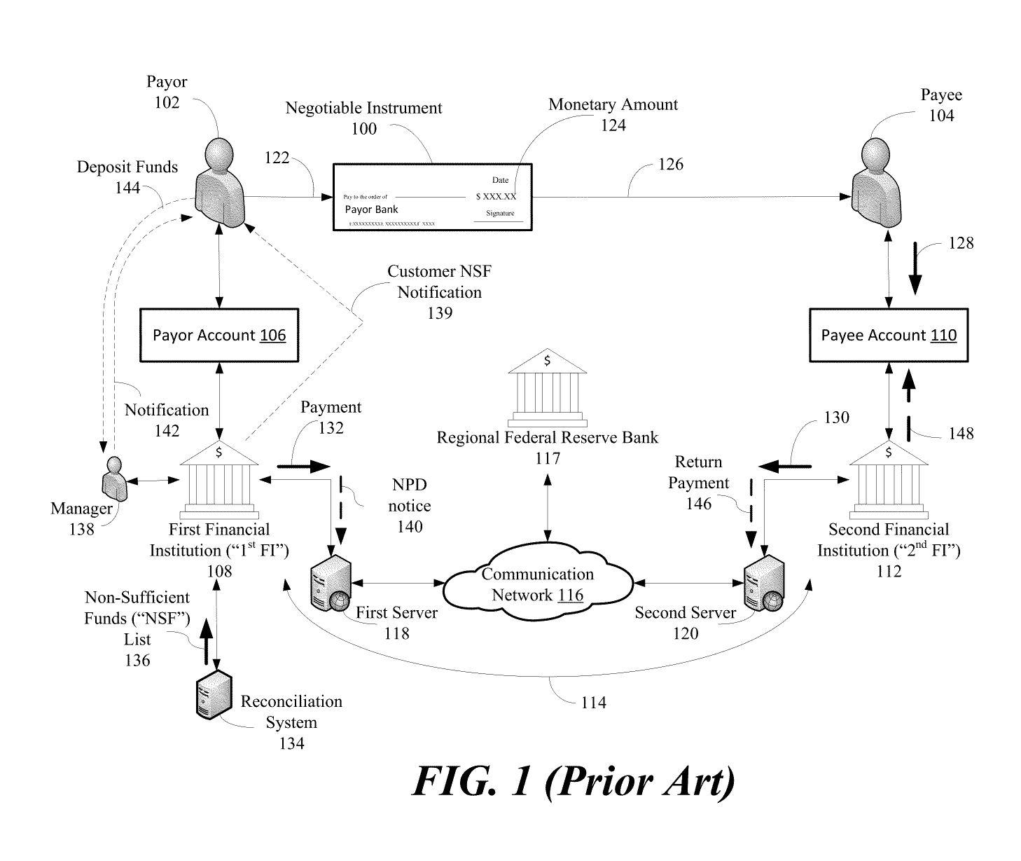

### DETAILED DESCRIPTION

A financial Alert Management System (“FAMS”) is described having a Financial Measure of Good Action Metric System (“MOGA”) in accordance with the present invention. The FAMS is a system that reduces the occurrence of a non-payment event where a first financial institution (“1st FI”) refuses or declines to pay a negotiable instrument generated by a Payor having a Payor account at the 1st FI, where the negotiable instrument has caused a non-sufficient funds (“NSF”) occurrence because the monetary amount of the negotiable instrument exceeds an available funds amount in the Payor account.

### 1. FAMS

The FAMS may include a first communication module, a database, a timing module, a second communication module, a payment module, mobile interface for financial alert system, and a controller. The controller may be in signal communication with the first communication module, second communication module, payment module, timing module, and database. The controller is configured to control the operation of the FAMS. The first communication module is configured to receive an NSF list, Payor contact list, and a FI predetermined time period from the 1st FI. The 1st FI produces the NSF list that includes the NSF occurrence as an NSF item within the NSF list, the Payor contact list that includes contact information for Payor, and the FI predetermined time period for receiving funds to cover the NSF occurrence before the 1st FI refuses to pay the negotiable instrument. The database is configured to store the NSF items from the NSF list and the contact information for the Payor from the Payor contact list and the timing module is configured to generate a FAMS predetermined time period based on the FI predetermined time period. The second communication module is configured to attempt communication with the Payor based on the contact information for the Payor and, if successful, communicate to the Payor the NSF occurrence, the need to pay at least the amount necessary to cure the NSF occurrence, and the FAMS predetermined time period and the payment module is configured to receive a payment from the Payor. The first communication module is further configured to send a payment notice to the 1st FI such that the 1st FI does not refuse to pay the negotiable instrument.

As an example of operation, the FAMS performs a method that reduces the occurrence of a non-payment event where the 1st FI refuses to pay the negotiable instrument generated by the Payor, where the negotiable instrument has caused a NSF occurrence because the monetary amount of the negotiable instrument exceeds the available funds amount in the Payor account. The method includes receiving the NSF list, Payor contact list, and FI predetermined time period from the 1st FI, storing the NSF items from the NSF list and storing the contact information for the Payor from the Payor contact list, generating a FAMS predetermined time period based on the FI predetermined time period, and attempting communication with the Payor based on the contact information for the Payor. If the attempted communication is successful, the method may also include communicating to the Payor the NSF occurrence, the need to pay at least the amount necessary to cure the NSF occurrence, and the FAMS predetermined time period to receive the payment. The method also includes receiving a payment from the Payor within the predetermined time period and sending a payment notice to the 1st FI such that the 1st FI does not refuse to pay the negotiable instrument.

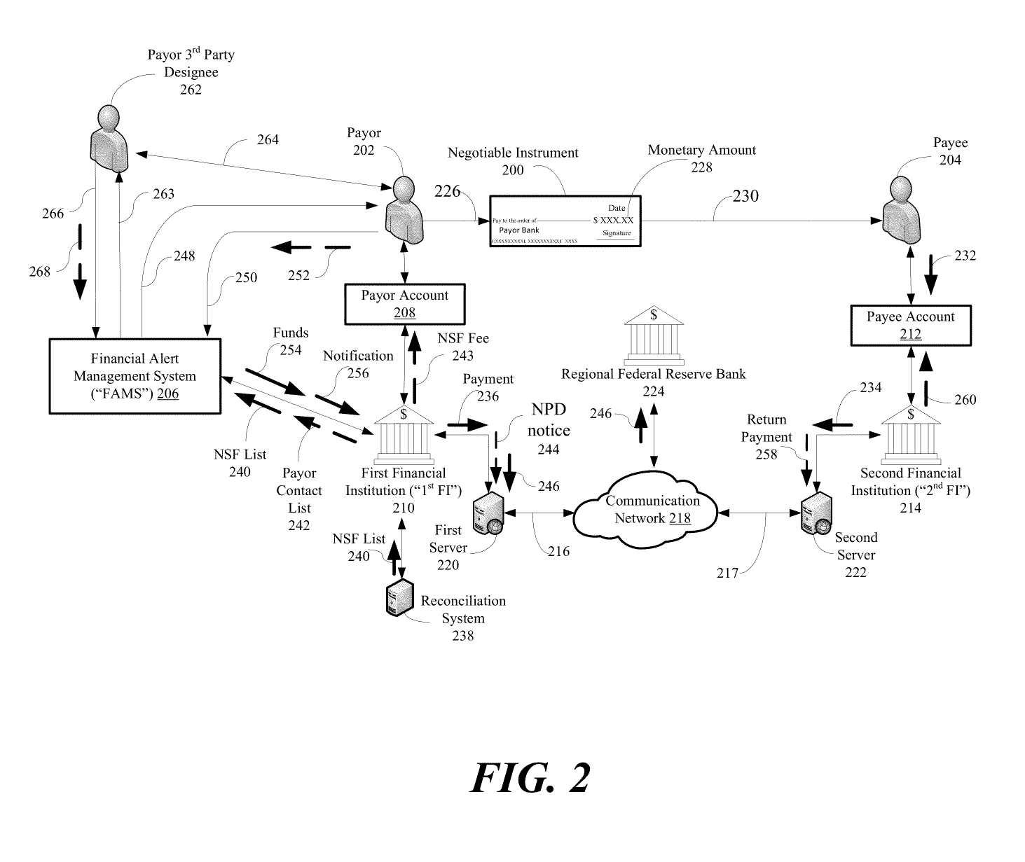

In FIG. 2, a block diagram of an example of an implementation of a system for an improved way of paying with a negotiable instrument 200 between two people 202 and 204 utilizing a Financial Alert Management System (“FAMS”) 206 is shown. In this example, the first person 202 is a Payor and the second person 204 is a Payee. The Payor 202 has a Payor account 208 at a first financial institution (“1st FI”) 210 and the Payee 204 has a Payee account 212 at a second financial institution (“2nd FI”) 214. In this example, the 1st FI 210 and 2nd 214 are in signal communication with each through the combination of signal paths (216 and 217) and any known communication network 218. The communication network 218 may be a computer network such as, for example, the Internet, another open network, a proprietary secure network, or a combination of networks. The signal paths 216 and 217 between the 1st FI 210 and 2nd FI 214 may include a first computer server 220 (at the 1st FI 210) and a second computer server 222 (at the 2nd FI 214). It is appreciated that the Payor 202, Payee 204, or both, may be optionally business entities instead of individuals. Additionally, the Payor account 208, Payee account 212, or both, may be, for example, checking accounts. Moreover, it is appreciated that the communication network 218 may be in signal communication with a regional Federal Reserve Bank 224. There are twelve regional Federal Reserve Banks in the Federal Reserve System that include the Federal Reserve Banks of Atlanta, Boston, Chicago, Cleveland, Dallas, Kansas City, Minneapolis, New York, Philadelphia, Richmond, San Francisco, and St. Louis.

Furthermore, it is appreciated by those skilled in the art that some of the circuits, components, modules, and/or devices of the system disclosed in the present application are described as being in signal communication with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical such as, for example, conductive wires, electromagnetic wave guides, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information is passed from one circuit, component, module, and/or device to another in varying analog and/or digital formats without passing through a direct electromagnetic connection. These information paths may also include analog-to-digital conversions (“ADC”), digital-to-analog (“DAC”) conversions, data transformations such as, for example, fast Fourier transforms (“FFTs”), time-to-frequency conversations, frequency-to-time conversions, database mapping, signal processing steps, coding, modulations, demodulations, etc.

In an example of operation, the Payer 202 generates 226 the negotiable instrument 200 (such as, for example, a check, substitute check, or automated clearing house (“ACH”) payment) that lists a monetary amount 228 and passes 230 it to the Payee 204 either physically or electronically. In this example, the negotiable instrument 200 is drawn on the Payor account 208 such that the Payor 202 is a “Drawer” of the Payor account 208 and the 1st FI 210 is a “Drawee” because the 1st FI 210 is where the negotiable instrument 200 can be presented for payment from the Payor account 208. Once received by the Payee 204, the Payee 204 then deposits 232 the negotiable instrument 200 into the Payee account 212 either physically or utilizing remote deposit under the Check 21 Act. Alternatively, if the Payor 202 pays the Payee 204 via an ACH transaction the payment is sent directly to Payee Account 212. Once the negotiable instrument 200 is deposited into the Payee account 212, the 2nd FI 214 may present 234 the negotiable instrument 200 (via for example, a substitute check) to the 1st FI 210 for payment via the signal path 216 that includes the communication network 218. In response, the 1st FI 210 sends a payment 236 for the monetary amount listed 228 on the negotiable instrument 200 via a computerized system (such as, for example, first computer server 220) utilizing the proper software. The 1st FI 210 may utilize a Check21 compliant system, an account (not shown) at the regional Federal Reserve Bank 224, or other interbank transaction system.

In this example, once the 1st FI 210 has sent the payment 236 to the 2nd FI 214, the 1st FI 210 then acts to withdraw (i.e., begins a procedure to withdraw but does not actually withdraw) the funds from the Payor account 208 and determines if there are sufficient funds available in the Payor account 208 to pay the listed monetary amount 228 of the negotiable instrument 200 utilizing a reconciliation process. If the funds are available in the Payor account 208, the listed monetary amount 228 of the negotiable instrument 200 is withdrawn from the Payor account 208 to satisfy the payment 236 made by the 1st FI 210. If, instead, the 1st FI 210 determines that there are insufficient funds in the Payor account 208 to pay the listed monetary amount 228 of the negotiable instrument 200, the clearing process designates the negotiable instrument 200 as causing an NSF occurrence (also known as an NSF event) for the Payor account 208 and then places it as an NSF item on an NSF list that will be generated that day by the 1st FI 210. In this example, the clearing process may be performed by a computer system such as, for example, a reconciliation system 238. The reconciliation system 238 may be optionally part of the first server 220 or another independent computer system of the 1st FI 210. The reconciliation system 238 may include software that includes rules and decision engines/modules to perform the reconciliation process that reconciles the amount paid on behalf of the Payor 202 with the funds available from the Payor account 208. The reconciliation system 238 has access to the 1st FI 210 customer lists and corresponding accounts such that it may generate a daily NSF list 240 that includes all NSF occurrences with the corresponding negotiable instruments that caused the NSF occurrences, the corresponding accounts of the negotiable instruments, and the corresponding customer information of the accounts. This NSF list 240 is then sent to the FAMS 206. A Payor contact list 242 of the contact information for corresponding Payors that caused the NSF items of the NSF list 240 may also be sent to the FAMS 206. It is appreciated that the Payor contact list 242 may not be sent if all relevant customer contact information is already provided in the NSF list 240. Additionally, if the FAMS 206 is part of the 1st FI 210, there may not be a need to send the Payor contact list 242 because the information is already available to the FAMS 206 through access to other databases (not shown) within systems located or controlled by the 1st FI 210. At this point, the 1st FI 210 may generate an optional NSF fee 243 that may be charged against the Payor account 208 for the specific NSF occurrence.

In this example, the Payor contact information in the Payor contact list 242 may include, for example, the account number corresponding to the NSF item, Payor's name, Payor's home, work, and/or mobile telephone numbers, Payor's work and/or personal emails, mobile text number, social security number, date of birth, home and/or business address, third-party contact information (i.e., a “3rd party designee” such as, for example, contact information for a spouse, parent, offspring, sibling, friend, business colleague or associate, etc.), and Payor's personal preferences. In this example, FAMS 206 may be a system that is either a part of 1st FI 210 or a third-party system that is controlled and operated by an independent organization (i.e., a “FAMS organization”) that is associated with the 1st FI 210. If FAMS 206 is a third-party system, the FAMS organization may have a contractual relationship with the 1st FI 210. Additionally, the FAMS organization may also have contractual relationships with individual customers that may include Payor 202. In the case of the FAMS organization having contractual relationships with individual customers such as, for example, Payor 202, the FAMS 206, as described below, allows an extra-level of protection for the Payor 202 to deal with a potential NSF occurrence.

Once the NSF list 240 is provided to FAMS 206, the 1st FI 210 will pause sending any Non-paid deposit notices (“NPD notices”) 244 to the 2nd FI 214, where each NPD notice 244 corresponds to an NSF item on the NSF list 240 (including the NSF item corresponding to the NSF occurrence caused by the negotiable instrument 200). In general, a NPD notice is a notification from the 1st FI 210 to the 2nd FI 214 that a request for the return of a deposited item. Specifically in this example, the NSF occurrence that was caused by the negotiable instrument 200 will be listed as an NSF item on the NSF list 240, which is passed to the FAMS 206, and then the 1st FI 210 will pause the sending of a NPD notice 244 to the 2nd FI 214 (which corresponds to the NSF occurrence caused by the negotiable instrument 200) for a 1st FI predetermined time period. In the example of a third-party FAMS organization, the pausing of sending the NPD notice 244 may be partly based on the contractual conditions agreed to by the FAMS organization and a plurality of FIs that include both the 1st FI 210 and 2nd FI 214. Alternatively, in case of the FAMS 206 being a system controlled and operated by the 1st FI 210, the FAMS 206 itself may pause the sending of the NPD notice 244 for the 1st FI predetermined time period. The 1st FI predetermined time period is generally the time from which the NSF occurrence was identified by the 1st FI 210 to the 1st FI cut-off time to reconcile the accounts at the 1st FI 210 at which time financial reconciliation information 246 needs to be sent from the 1st FI 210 to one of regional Federal Reserve Banks 224 unless the 1st FI 210 utilizes a difference reconciliation process that is based on a contractual settlement process between the plurality of FIs (which includes both 1st FI 210 and 2nd FI 214) that does not utilize the regional Federal Reserve Bank 224. This 1st FI cut-off time may vary based on the time zone of the corresponding Regional Federal Reserve Bank 224 with which the 1st FI 210 has an account, such that the 1st FI predetermined time period may be less for a Payor located on the west coast that is utilizing a FI located on the east coast of the U.S. versus an FI located on the west coast.

If FAMS 206 is a third-party system, once the FAMS 206 receives the NSF list 240 and the Payor contact list 242, the FAMS 206 attempts to contact 248 the Payor 202 via one or more electronic contact methods based on the contract information provided for the Payor 202. This may include, for example, robo-calling the Payor's home, work with either pre-recorded or computer generated voice messages, and/or mobile telephone numbers, generating a computer message that can be utilized by a call center person to call and potentially talk to the Payor, sending computer generated text messages to Payor's mobile, sending computer generated emails to the Payor's personal and/or work emails. If contact 248 with the Payor 202 is established (i.e., someone picked up the phone when called by the FAMS 206, FAMS 206 was able to leave a voicemail on one of the listed telephone numbers, or FAMS 206 texts and/or emails were sent without bouncing back) by the FAMS 206, the FAMS 206 may be configured to note the time that contact was made in its database (not shown) and it may keep track of the time left to for the Payor 202 to respond before a FAMS predetermined time period runs out or a FAMS additional or repeat contact may be made. The FAMS 206 will then communicate in all its communications with the Payor 202 the FAMS predetermined time period to respond to the Payor 202. The FAMS predetermined time period may be equal to or less than the 1st FI predetermined time period. If the Payor 202 responds 250 to the FAMS 206 within the predetermined time period, the FAMS 206 will attempt to negotiate a way of avoiding the NPD notice 244 being sent to the 2nd FI 214. This negotiation involves receiving a payment 252 from the Payor 202 that will cover the NSF occurrence caused by the negotiable instrument 200 before the expiration of the FAMS predetermined time period.

This payment 252 will include at least the necessary amount of funds to cover the insufficient amount resulting from the monetary amount 228 of the negotiable instrument 200 being applied against the available funds in the Payor account 208. The payment 252 may also include a FAMS 206 proceeding fee, NSF fee 243, and other fees. The payment 252 is optional in that making the payment 252 is at the discretion of the Payor 202. If the payment 252 is made within the FAMS predetermined time period, then the FAMS 206 receives the payment 252, optionally deducts the FAMS 206 processing fee, and sends the remaining funds 254 to the 1st FI 210. The funds 254 are received by the 1st FI 210, applied to the Payor account 208 to reconcile one or more of the negotiable instruments that caused the NSF occurrence in the account, and, as such, the 1st FI 210 does not send the NPD notice 244 (corresponding to the NSF occurrence caused by the negotiable instrument 200) to the 2nd FI 214. In this example, as long as the Payor 202 makes a payment 252 to the FAMS 206 before the expiration of the FAMS predetermined time period, the 1st FI 210 will either pay the 2nd FI 214 (if a prior pre-reconciliation payment 236 was not paid), or not send the NPD notice 244 if the payment 236 had been made. It is appreciated that the FAMS predetermined time period communicated to the Payor 202 is either less than the FI predetermined time period because the FAMS predetermined time period takes into account the time lag in receiving the payment 252 from the Payor 202 and the actual FI predetermined time period or because the FAMS organization has a contractual agreement with the 1st FI 210 that if the FAMS 206 receives the payment 252 within the FI predetermined time period, it will guarantee payment to the 1st FI 210 with the funds 254. This disclosure also includes segregating Payors into groups which have been defined by attributes or criteria including but not limited to different pre-determined time periods. Such criteria may be related to FI or FAMS historical dealings with Payor, contractual agreement with Payor, estimate of credit worthiness of the Payor and the like.

In this case, since the FAMS organization is an independent entity from the 1st FI 210, the FAMS organization may choose to allow the FAMS 206 to accept non-cash payments or even cash payments at non-1st FI 210 locations from the Payor 202. As an example, the FAMS 206 may accept cash payments at branches or automated teller machines (“ATMs”) of other FAMS organization member FIs and may optionally charge an additional fee that may include a FAMS deposit fee and a receiving FI's deposit fee. Additionally, the FAMS 206 may accept payments from accounts at other FIs, wire transfer, ACH transactions, cashier's checks, one or more credit card payments, one or more gift card payments, one or more prepaid credit cards, one or more prepaid gift cards, one or more debit cards, PayPal® payments, money orders, foreign currency, MoneyGram® from Western Union® payments, credit line, home equity line, bit coin, digital currency, reward points, or combination of these. Moreover, the FAMS 206 may allow the Payor 202 to apply, get approved, and be provided with a financial loan that will cover at least the funds needed for the payment 252. The financial loan may be based on the credit worthiness of the Payor 202.

In the case that the Payor 202 does not contact 250 the FAMS 206 within the FAMS predetermined time period or does contact the FAMS 206 but does not either agree to make the necessary payment 252 or makes the payment 252 past the expiration of the FAMS predetermined time period, the FAMS 206 either notifies 256 the 1st FI 210 that payment has not been made or simply does not make the funds payment 254 to the 1st FI 210 within the FI predetermined time period. As such, at the expiration of the FI predetermined time period the 1st FI will notify 210 the 2nd FI 214 that the negotiable instrument 200 is not paid. Or in those cases when the 1st FI 210 automatically paid the 2nd FI 214 before reconciling the negotiable instruments, the 1st FI 210 will send the NPD notice 244 to the 2nd FI 214 demanding repayment of the earlier payment 236 made to the 2nd FI 214 in relation to the listed monetary amount 228 electronically paid for the negotiable instrument 200. The 2nd FI 214 will return the payment 258 to the 1st FI 210 less a charge back or cost for the transaction. The 2nd FI 214 may then optionally charge the Payee 204 a returned payment fee 260 which will be withdrawn from the Payee account 212. The Payee 204 is then left to enforce the payment of the listed monetary amount 228 owed by the Payor 202 by himself/herself. As stated above, this could result in possible undesirable legal, personal financial, personal reputation, and criminal issues for the Payor 202.

Additionally, if contact information is available for a third-party (“3rd party”) designee 262, the FAMS 206 may try to contact 263 the Payor's 3rd party designee 262 based on the information provided by the 1st FI 210 (in the Payor contact list 242) or a customer database (not shown) of the FAMS 206 if the Payor 202 is a customer of the FAMS organization. Once the 3rd party designee 262 is contacted, the FAMS 206 may instruct the 3rd party designee 262 to contact 264 the Payor 202 so that the Payor 202 may respond to the request within the FAMS predetermined time period and/or allow the 3rd party designee 262 to respond 266 directly to the FAMS 206 for payment arrangements. If the Payor 202 responds 250 to the FAMS 206 in response to the FAMS 206 contacting 264 the 3rd party designee, the process proceeds as described earlier. If, on the other hand, the 3rd party designee 262 responds 266 to the FAMS 206, the FAMS 206 may allow the 3rd party designee 262 to make the same type of payment 268 arrangements as described above in relation to the Payor 202. In this case, if the 3rd party designee makes a payment 268 (similar to payment 252 made by the Payor 202) within the FAMS predetermined time period, the 1st FI 210 will not send the NPD notice 244 to the 2nd FI 214.

Specifically, the payment 268 is again optional in that making the payment 268 is at the discretion of the 3rd party designee 262. Similar to payment 252, the payment 268 will include at least the necessary amount of funds to cover the insufficient amount resulting from the monetary amount 228 of the negotiable instrument 200 being applied against the available funds in the Payor account 208. The payment 268 may also include a FAMS 206 proceeding fee, the NSF fee 243, and other fees. If the payment 268 is made within the FAMS predetermined time period, then the FAMS 206 receives the payment 268, optionally deducts the FAMS 206 processing fee, and sends the remaining funds 254 to the 1st FI 210. The funds 254 are received by the 1st FI 210, applied to the Payor account 208 to reconcile one or more of the negotiable instruments that caused the NSF occurrence in the account, and, as such, the 1st FI 210 does not send the NPD notice 244 (corresponding to the NSF occurrence caused by the negotiable instrument 200) to the 2nd FI 214. In this example, as long as the 3rd party designee 262 makes a payment 268 to the FAMS 206 before the expiration of the FAMS predetermined time period, the 1st FI 210 will either pay 236 the 2nd FI 214 (if a prior pre-reconciliation payment 236 has not been made) or not send the NPD notice 244. Again, it is appreciated that the FAMS predetermined time period communicated to the 3rd party designee 262 is either less than the FI predetermined time period because the FAMS predetermined time period takes into account the time lag in receiving the payment 268 from the 3rd party designee 262 and the actual FI predetermined time period or because the FAMS organization has a contractual agreement with the 1st FI 210 that if the FAMS 206 receives the payment 268 within the FI predetermined time period, it will guarantee payment to the 1st FI 210 with the funds 254.

It is appreciated, that the FAMS 206 may allow for a combination of payments 252 and 268 from both the Payor 202 and 3rd party designee 262.

Again, in this case, since the FAMS organization is an independent entity from the 1st FI 210, the FAMS organization may choose to allow the FAMS 206 to accept non-cash payments or even cash payments at non-1st FI 210 locations from the 3rd party designee 262. As an example, the FAMS 206 may accept cash payments at branches or ATMs of other FAMS organization member FIs and may optionally charge an additional fee that may include a FAMS deposit fee and a receiving FI's deposit fee. Additionally, the FAMS 206 may accept payments from accounts at other FIs, wire transfer, ACH transactions, cashier's checks, one or more credit card payments, one or more gift card payments, one or more prepaid credit cards, one or more prepaid gift cards, one or more debit cards, PayPal® payments, money orders, foreign currency, MoneyGram® from Western Union® payments, credit line, home equity line, bit coin, digital currency, reward points, or combinations of these. Moreover, the FAMS 206 may allow the 3rd party designee 262 to apply, get approved, and be provided with a financial loan that will cover at least the funds needed for the payment 252. The financial loan may be based on the credit worthiness of the 3rd party designee 262.

In this example, the FAMS 206 may generate a unique identifier code (“FAMS UIC”) to uniquely identify the NSF item (or items) corresponding to the Payor. The FAMS 206 may generate a plurality of FAMS UICs that are stored in a database (not shown) corresponding to different NSF items. By utilizing the plurality of FAMS UICs, corresponding FI that are associated with the FAMS organization may utilize the FAMS UICs to identify a NSF item and the corresponding Payor. As such, in this example, the Payor 202 or 3rd party designee 262 may go to another FI (such as, for example, 2nd FI 214) to make a payment 252 or 268. Once at the other FI, the Payor 202 or 3rd party designee 262 may present the FAMS UIC to a FI teller (or enter it in an automated payments station such as, for example an ATM) and the FI teller or automatic payment station will recognize the FAMS UIC and allow the payments 252, 268, or combination of both, to be made. In this example, the other FI may charge a FAMS convenience fee to the Payor 202 or 3rd party designee 262. Similarly, with the FAMS UIC, the FAMS 206 may allow the Payor 202 or 3rd party designee 262 to pay via a telephone call center, online via an Internet website, and via a mobile application.

In addition to FAMS UIC, the FAMS 206 may utilize coded messages to allow the Payor 202 to keep his/her privacy. These communications may be coded via safe word, alpha numeric code, or other private type of communication.

If the FAMS 206 is a system within the 1st FI 210, the operation is basically the same as described above, except that the NSF list 240 and Payor contact list 242 is information that is internally (i.e., within the 1st FI 210) accessed by the FAMS 206. Additionally, since the FAMS 206 is part of the 1st FI 210, the FAMS predetermined time period and FI predetermined time period is the same. Moreover, since the FAMS 206 is part of the 1st FI 210, the FAMS 206 does not need to send funds 254 to the 1st FI 210 and notification 256 that a payment has not been made would be replaced by an internal confirmation that the payment, rather than be deposited in the Payor's account, was to be applied to remove the already processed NSF item from the NSF list. In this example, the payment 252 or 268 for the Payor 202 or 3rd party designee 262 would be made directly to the 1st FI 210.

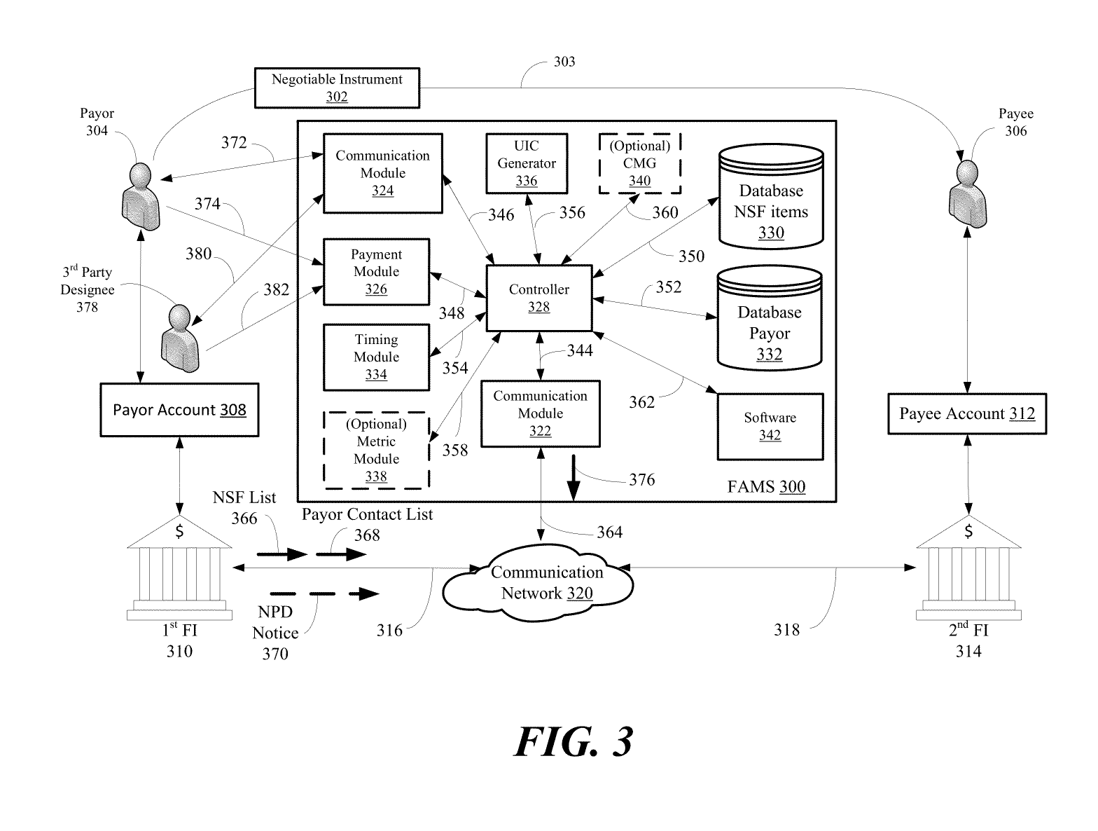

In FIG. 3, a block diagram of an example of an implementation of a third-party FAMS 300 that reduces the effects of an NSF occurrence caused by a negotiable instrument 302 that is utilized by a Payor 304 to pay 303 a Payee 306 is shown. As described earlier, the Payor 304 may have a Payor account 308 at a 1st FI 310 and the Payee 306 may have a Payee account 312 at a 2nd FI 314. Again, the 1st FI 310 and 2nd FI 314 may be in signal communication via a signal paths 316, 318, and communication network 320 that may be, for example, the Internet. The FAMS 300 may include a first communication module 322, second communication module 324, payment module 326, controller 328, database of NSF items 330, database of Payors 332, timing module 334, UIC generator 336, optional metric module 338, and software module 342 In this example, the controller 328 may be in signal communication with first communication module 322, second communication module 324, payment module 326, database of NSF items 330, database of Payors 332, timing module 334, UIC generator 336, optional metric module 338, optional coded message generator (“CMG”) 340, and software module 342 via signal paths 344, 346, 348, 350, 352, 354, 356, 358, 360, and 362, respectively. In this example, the FAMS 300 may be integrated into a single signal computer system or, alternatively, may be integrated over multiple computer systems. The FAMS 300 may be in signal communication with the 1st FI 310 via signal paths (316 and 364) and communication network 320. Similarly, the FAMS 300 may (optionally) also be in signal communication with the 2nd FI 314 via signal paths (318 and 364) and communication network 320.

Based on the description in FIG. 2, in FIG. 3 an example of operation of the FAMS 300 starts when the FAMS 300 receives an NSF list 366 and Payor contact list 368 from the 1st FI 310 at the first communication module 322. If the negotiable instrument 302 has caused an NSF occurrence, the negotiable instrument 302 will be listed as an NSF item of the NSF list 366. Additionally, the Payor's account information, contact information, and possible personal information is passed to the FAMS 300 via a Payor contact list 368. This information is received by the first communication module 322 and passed to the database of NSF items 330 and database of Payors 332, respectively. The controller 328 and/or UIC generator 336 may generate UICs for the NSF items of the NSF list 366 and the Payors information on the Payor contact list 368 utilizing the database of NSF items 330 and database of Payors 332. The UICs may be utilized by the FAMS 300 as a customer and payment identification number. As an example, a UIC may be utilized as a temporary payment routing number that allows reception of payments by or on behalf of Payor 304 to Payor account 308. The UIC may be, as an example, an alpha numeric code that uniquely identifies the Payor within the FAMS 300 and an FI that are associated with the FAMS organization. The controller 328 and/or timing module 334 may then determine a FAMS predetermined time period based on the information provided in the NSF list 366 which includes the time that NSF items were identified by the 1st FI 310 and the possibly the FI predetermined time period that the 1st FI 310 has until it needs to send an NPD notice 370 to the 2nd FI 314 and/or regional Federal Reserve Bank (not shown). The controller 328 and/or a message module (not shown) may generate a voice pre-recorded or machine generated message to send via telephone or a textual message to send via textual communications means such as, for example, email, mobile text messaging, or social media based text messaging. The message may be explicit such as, for example, “You need to contact Bank ‘A’ regarding reference number XXXX.” In the case that the Payor 304 is a customer of the FAMS organization, the message may be even more explicit such as, for example, “You need to contact Bank ‘A’ regarding X number of NSF items, please use reference number XXXX.” Alternatively, the controller 328 and optional CMG 340 may then optionally generate a coded message to send to the Payor 304 in instances when privacy is required such that less explicit communications and/or codes may be utilized. These coded communications may be coded via a safe word or password. The controller 328 and/or second communication module 324, in combination with the database of Payors 332 may then attempt to contact 372 the Payor 304 via the different forms of contact provided the Payor contact list 368 or Payor 304 provided contact information if the Payor 304 is a customer of the FAMS organization. The second communication module 324 may time stamp each communication attempt with the Payor 304 and store that time stamp in the database of NSF items 330, database of Payors 332, other database (not shown), or combination of one or more of these. The time stamp may include the data and time that the attempted communication was made. The FAMS 300 may also record in one of the databases that time stamp, form of communication attempted, and whether the attempt was successful in reaching the Payor 304—i.e., a voicemail was left on the cellphone of the Payor, the Payor 304 received the call and possibly gave confirmation of receiving the call, and an email and/or text message was successfully sent. In these examples, each successful form of communication send to the Payor 304 includes also communicating the FAMS predetermined time period and the need for the Payor 304 to respond to the FAMS 300 before the expiration of the FAMS predetermined time period. If the Payor 304 responds to the FAMS 300 before the expiration of the FAMS predetermined time period, the FAMS 300 will inform the Payor 304 what the possible options are to correct the situation. The FAMS 300 will communicate to the Payor 304 what the required payment 374 is, how it can be paid, and what the time limit to pay based on the FAMS predetermined time period. The payment module 326 is a device, devices, subsystem, or software/hardware module that is capable of receiving the payment 374 from the Payor 304. Examples of the payment module 326 may include a website interface, software and hardware required to allow reception of payment 374 at other FI, at ATMs, via electronic funds transfers systems, etc. Once a payment 374 is received by the payment module 326 within the FAMS predetermined time period, the payment module 326 (either by itself or in combination with other FAMS 300 subsystems) may send funds 376 to the 1st FI 310 within the FI predetermined time period. The payment module 326 by itself, or in combination with other FAMS 300 subsystems (such as, for example, the timing module 334), may time stamp the date and time of reception of the payment 374 from the Payor 304. This information may then be saved into one of the databases in the FAMS 300. The optional metric module 338 may then evaluate how the Payor 304 responds to NSF occurrences and, as a result, assign a quality score based on the historic performance of Payor 304 in responding the NSF occurrences caused by the Payor 304.

If the FAMS 300 is unsuccessful in reaching the Payor 304 or if the Payor 304 designates a 3rd party designee 378, the FAMS 300 will attempt to contact 380 the 3rd party designee 378. The FAMS 300 may utilize the same process (described earlier) in contacting 380 the 3rd party designee 378 as was utilized in attempting to contact 372 the Payor 304. However, the messages will typically be different because the messages may attempt to reach the Payor 304 through the 3rd party designee 378 and possibly allow the 3rd party designee 378 to make a payment 382 to the FAMS 300 for the Payor 304. In this variation, the controller 328 and/or a message module (not shown) may generate a voice pre-recorded or machine generated message to send via telephone or a textual message to send via textual communications means such as, for example, email, mobile text messaging, or social media based text messaging. The message may be explicit such as, for example, “Please let [Payor] know that he/she needs to contact Bank ‘A’ regarding reference number XXXX.” In the case that the Payor is a customer of the FAMS organization, the message may be even more explicit such as, for example, “Please let [Payor] that they need to contact Bank ‘A’ regarding X number of NSF items, please use reference number XXXX.” Alternatively, the controller 328 and/or optional CMG 340 may then optionally generate a coded message to send to the 3rd Party designee 378 in instances when privacy is required such that less explicit communications and/or codes may be utilized. This coded message may be different than the coded message that would be generated for the Payor 304 had the FAMS 300 contacted 372 the Payor 304 directly. As mentioned earlier, the message to the 3rd Party designee 378 may also include information allowing the 3rd party designee 378 to make the payment 382 for the Payor 304. In this example, the message to the 3rd party designee 378 may be, for example, “Hello [3rd party designee] we are contacting you in an attempt to reach [Payor] regarding the need to contact Bank ‘A’ regarding an urgent issue. If you would like to contact Bank ‘A’ for [Payor], please use reference number XXXX.”

In this example, the payment module 326, timing module 334, UIC generator 336, optional metric module, and optional CMG may be modules and/or devices that are implemented in hardware, software, or combinations of both. Each of these modules may be software modules that run on a processor (such as, for example, controller 328 or other processor that is not shown) which may include a central processing unit (“CPU”), digital signal processor (“DSP”), application specific integrated circuit (“ASIC”), field programmable gate array (“FPGA”), microprocessor, etc. Alternatively, each module may also be or include hardware devices such as logic circuitry, a CPU, a DSP, ASIC, FPGA, etc. The first communication module 322 and second communication module 324 may include hardware and software capable of receiving and sending information to the communication network 320 (such as, for example, Internet and/or Ethernet circuitry) and other communication hardware and software capable of accessing the Internet, email, the cellular telephone network, the landline telephone network, PCS services, mobile text services, etc. The database of NSF items 330 is a FAMS 300 database capable of storing all the NSF items received by the FAMS 300 from the associated FIs through the NSF list 366 or through another sharing of customer information. The database of Payors 332 is another FAMS 300 database capable of storing all the customer information related to the Payors that may either be received from the associated FIs (through the NSF list 366, Payor contract list 368, or combination of both) or from the individual customers (that may include Payor 304) themselves. The FAMS 300 may also include other databases and storage devices (such as random access memory (“RAM”) modules), which are not shown, that allow the processing of the data within the database of NSF items 330 and database of Payors 332. The controller 328 may be any type of processor capable of controlling the functions and operation of the modules the FAMS 300. It is appreciated that the controller 328 may actually be multiple controllers acting in coordination to control the operation of the FAMS 300. The software module 342 may include a storage device, or devices, that stores the software needed to run the controller 328 or other FAMS 300 modules 322, 324, 326, 330, 332, 334, 336, 338, and/or 340.

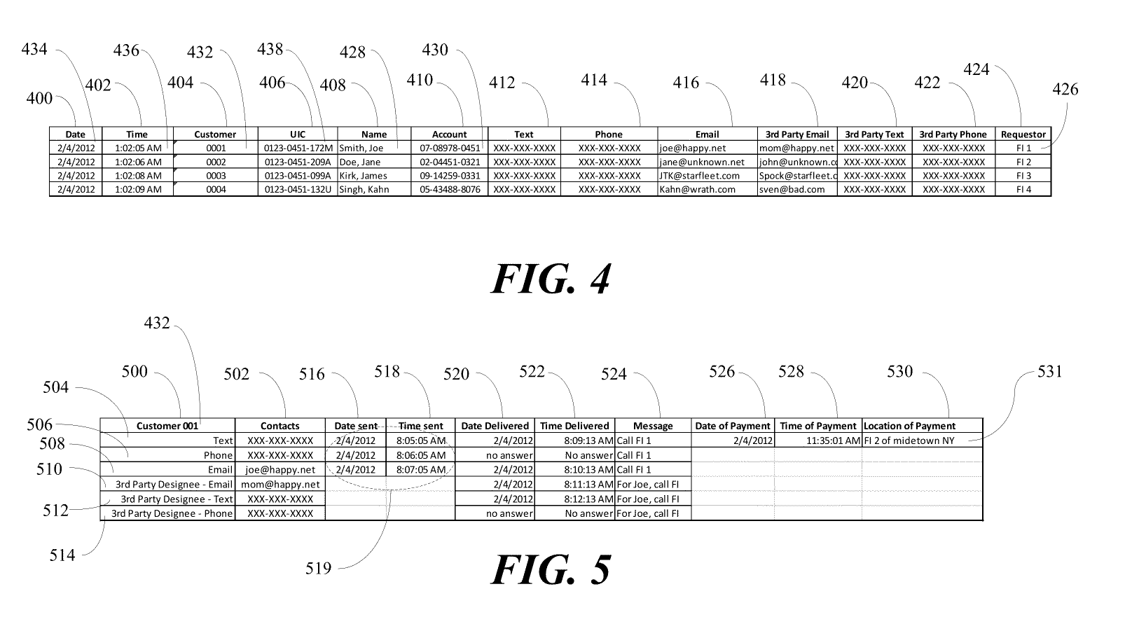

Turing to FIGS. 4 and 5, in FIG. 4, a table that includes tabular data regarding the NSF items and contact information for the Payors corresponding to the NSF items is shown. In this example, the table may include the date 400 that the NSF item was generated, the time 402 that NSF item was communicated to the FAMS 300, a customer (or other title name for identifying the Payor) number 404, the UIC 406 for the Payor, the name 408 of the Payor, account number 410 for the Payor account, contact information for sending text messages 412, contact information for sending pre-recorded or machine generated audio messages to a telephone number 414, contact information for sending emails 416, contact information for sending emails 418 to the 3rd party designee, contact information for sending text messages 420 to the 3rd party designee, contact information for sending pre-recorded or machine generated audio messages to a telephone number 422 corresponding to the 3rd party designee, and information regarding the requestor 424 that sent the NSF item to the FAMS 300. The requestor is a typically an FI such that, for example, the table shows that “FI 1” 426 is the requestor FI that desires that the FAMS 300 contact Payor “Smith, Joe” 428 that has Payor account “07-08978-0451” 430. In this example, the FAMS 300 may assign a customer 404 number “0001” 432 with a time stamp of receipt having a data of “2/4/12” 434 and time “1:02:05 AM” 436 and a generated UIC 406 number of “0123-0451-172M” 438. Generally, this table is organized from the NSF list 366 and Payor contact list 368 by the FAMS 300 that may store this information into a FAMS 300 database.

In FIG. 5, a table that includes contact information related to customer 001 432 shown in FIG. 4. Unlike the table in FIG. 4, this table is specific to the NSF item and contact information for customer 001 432 of FIG. 4.

In this example, the table includes: the customer (or other title name for identifying the Payor) number 500; contact information 502 that corresponds to the contact information for sending text messages 504, contact information for sending pre-recorded or machine generated audio messages to a telephone number 506, contact information for sending emails 508, contact information for sending emails 510 to the 3rd party designee, contact information for sending text messages 512 to the 3rd party designee, contact information for sending pre-recorded or machine generated audio messages to a telephone number 514 corresponding to the 3rd party designee; time stamp data of time of receipt of the NSF item(s) that includes the date sent 516 and time sent 518 from the FI (as an example, from 1st FI 310), time stamp data of the date 520 and time 522 that the FAMS 300 contacted and sent the message to either the Payor or 3rd party designee; and a copy of the message sent 524. The date and time delivered 520 and 522 columns would include the actual dates and times that the messages were delivered (i.e., the Payor/3rd party designee has received the voice message or the FAMS 300 has left a voicemail on their respective telephones or the text or emails have been sent without being returned as undeliverable). If the messages were not delivered, the column entry would include a description of value indicating that there was “no answer,” “returned,” “undeliverable,” etc. Turning back to the columns for date sent 516 and time sent 518 from the FI, these columns also include other NSF items for that Payor (i.e., customer 001 432) that have occurred that day (i.e., date sent column 516). In this example, three NSF items 519 are shown in the FIG. 5. In this example, the time sent 518 for all three NSF items 519 vary from 8:05:05 AM to 8:07:05 AM; however, all three NSF items 519 may be sent by the FI to the FAMS 300 at the same time such as, for example, all three NSF items may be sent at 8:05:05 AM. The table may also include columns for noting the date 526 that the Payor and/or 3rd party designee has made a payment including the time 528 that the payment was made, and the location 530 that the payment was made such as, for example, “2nd FI of midetown, NY” 531.

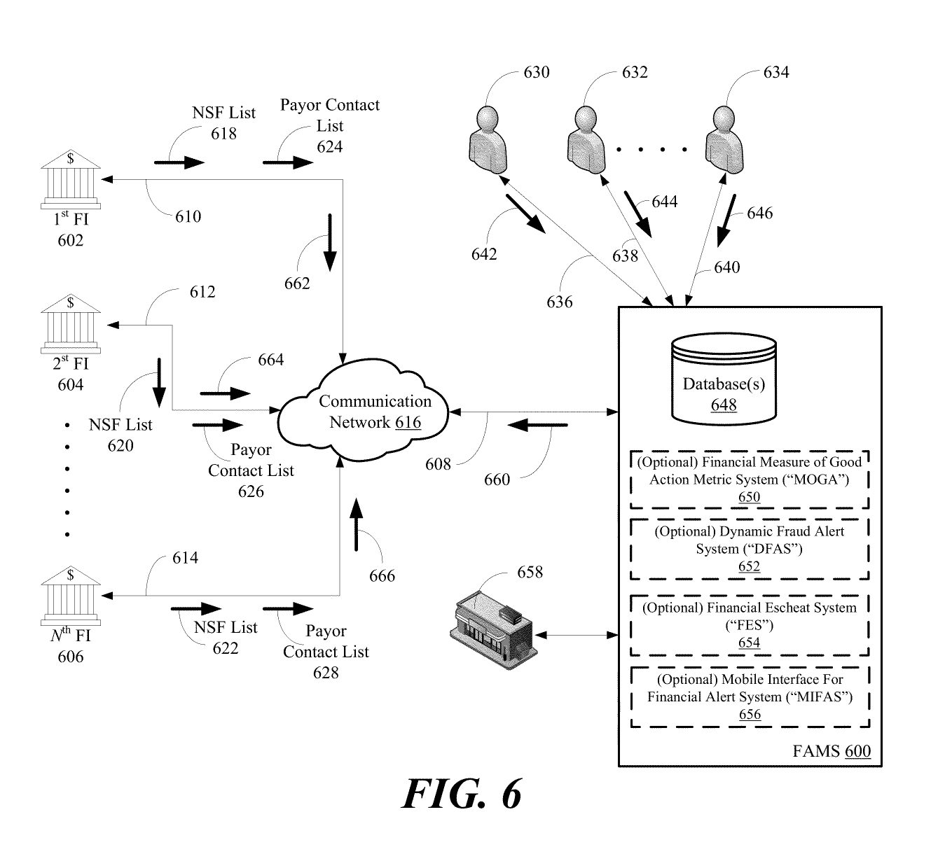

Based on the table showing the multiple requestors 424 shown in FIG. 4, we turn to FIG. 6. In FIG. 6, a block diagram of an example of an implementation of the FAMS 600 is shown in signal communication with a plurality of FIs. The FIs may be 1st FI 602, 2nd FI 604, through an Nth FI 606. It is appreciated by those skilled in the art that while only three FIs are shown in the figure, this is for simplicity and convenience and that there could be numerous FIs in signal communication with the FAMS 600, where “N” may represent any number greater than 3. Similar to the previous descriptions, the FAMS 600 may be in signal communication with the FIs 602, 604, and 606 via signal paths 608, 610, 612, and 614, and communication network 616, respectively. In this example, the FAMS 600 is a third-party entity which is independent of the FIs and may be part of the FAMS organization. The FAMS 600 may be implemented across multiple sub-FAMS 600 systems that work together sharing all the FAMS organization databases (i.e., the different databases within either the single FAMS or multiple FAMS system).

In this example, the FAMS 600 may receive multiple NSF lists 618, 620, and 622 and Payor contact lists 624, 626, and 628, from the 1st FI 602, 2nd FI 604, and Nth FI 606, respectively. The FAMS 600 may also have a plurality of individual customers 630, 632, and 634. In this example, the Payor described in FIGS. 2 through 5 may be also an individual customer of the FAMS 600. Again, it is appreciated that while only three individual customers 630, 632, and 634 are shown in the figure, this is for simplicity and convenience and that there could be numerous individual customers of the FAMS 600. These individual customers 630, 632, and 634 may be in signal communication with the FAMS 600 via signal paths 636, 638, and 640 that may include the different forms of communications described earlier such as, for example, voice messages, text messages, and/or email messages. In this example, the individual customers 630, 632, and 634 may provide their contact and personal information 642, 644, and 646, respectively, to the FAMS 600.

As the FAMS 600 receives the NSF lists 618, 620, and 622, Payor contact lists 624, 626, and 628, and contact and personal information from the individual customers 630, 632, and 634, the FAMS 600 may store all of the received data into one or multiple databases 648. From the information data in this (or these) database(s) 648, the FAMS 600 may organize and analyze this information data to provide a few optional features. These optional features would be to provide the FAMS 600 customers (both the FIs (602, 604, and 606) and the individual customers (630, 632, and 634) associated with the FAMS 600) with other types of financial alerts and information. Specifically, the FAMS 600 may include one of more modules such as, for example, an optional Financial Measure of Good Action Metric System (“MOGA”), an optional Dynamic Fraud Alert System (“DFAS”), an optional Financial Escheat System (“FES”), and an optional Mobile Interface for Financial Alert System (“MIFAS”).

### MOGA

In this example, the MOGA 650 may be utilized to create a historic rating of how customers (630, 632, and 634) resolve NSF occurrences on their Payor accounts (i.e., metric scores). In general, if they are timely in resolving the NSF occurrences and, therefore, do not cause their respective Payor FI to issue and/or send NPD notices to other FIs on their negotiable instruments that have caused the corresponding NSF occurrences, their MOGA 650 generated metric scores will be high. If, on the other hand, they are not timely in resolving the NSF occurrence and, therefore, do cause their respective Payor FI to issue and/or send NPD notices to other FIs on their negotiable instruments that have caused the corresponding NSF occurrences, their MOGA 650 generated metric scores will be low. These MOGA 650 generated metric scores may also take into account the number of NSF occurrences caused by Payors and the amounts that cause the NSF occurrences. These MOGA 650 generated metric scores may then be utilized by other customers to determine if they will accept a negotiable instrument from another person that has a MOGA 650 generated metric score. This may include individual customers 630, 632, and 634, and business entities that are FAMS 600 customers such, for example, retail store 658.

Another possible utilization of a MOGA 650 metric score is in a type of “credit score” for the individual customers 630, 632, or 634 because the metric score will help indicate how “good” an individual customer 630, 632, or 634 is in following through with their payments. Additionally, a high MOGA 650 metric score may allow the FAMS 300 to have some flexibility in how it deals with an individual customer 630, 632, or 634 when an NSF occurrence happens. Specifically, if an individual customer 630, 632, or 634 is a Payor that causes a NSF occurrence by generating and passing a negotiable instrument that causes an insufficient funds event, the FAMS 600 will receive the information on the NSF item caused by the Payor and will be able to compare the NSF item amount against the Payor's MOGA 650 metric score to determine the likelihood of the Payor paying on time the amount necessary to resolve the NSF occurrence. If the MOGA 650 metric score is high, the FAMS 600 may establish (unlike what was described earlier) a FAMS predetermined time period for the Payor to pay the FAMS 600 that is now greater than the FI predetermined time period. As described earlier, the FAMS predetermined time period is generally equal to or less than the FI predetermined time period so that the FAMS 600 has sufficient time to obtain a payment of funds from the Payor that caused the NSF occurrence. However, if that specific Payor has a history and a high MOGA 650 metric score that the FAMS 600 has been monitoring, the FAMS 600 may extend the FAMS predetermined time period to a time that is greater than the FI predetermined time period because the MOGA 650 may indicate that that this specific Payor is trustworthy enough to pay the amount required based on previous performances and that the FAMS 600 may take the risk of extending the time for the Payor to pay the funds even though that may expose the FAMS 600 to liability to FI if the Payor does not actually pay the FAMS 600. In this situation, the FAMS 600 may charge an additional fee (i.e., a payment time extension fee) to the Payor for extending the FAMS predetermined time period. This payment time extension fee may be part of subscription service if the Payor is a FAMS 600 customer. Based on this example, the FAMS 600 may either indicate to the corresponding FI that the Payor has made the payment and that the FI should pay the negotiable instrument that caused the NSF occurrence or FAMS 600 may send the required payment to the corresponding FI and then seek payment from the Payor. In this situation, the FAMS 600 could act, or facilitate, loaning time (optionally for a fee), or extending credit, a loan or a guarantee to the Payor based at least in part on the MOGA 650 metric score of the Payor.

### DFAS

Similar to MOGA 650, DFAS 652 would be a system and method that utilizes the information stored in the FAMS 600 database(s) 648. DFAS 652 may be utilized to constantly monitor the NSF items that are received by the different FIs against known Payor personal data. If multiple NSF items appear to be associated with the same Payor personal data (such as, for example, social security numbers, driver's license numbers, home addresses, telephone numbers, etc.) and these NSF items associated to the same Payor personal data are being received from different FIs, there is a chance that the Payor's personal data has been compromised and that someone is producing fraudulent negotiable instruments using the Payor's personal data. The DFAS 652 may then produce a fraud alert to all associated FIs and vendors (such as retail store 658) that informs these entities to hold, review, use caution or do not accept checks from this Payor until the fraud alert has been resolved. In the case of Payors that legitimately have different accounts at different FIs, this information should already be in the FAMS 600 database(s) and as such should not be a problem. An advantage of the DFAS 652 is that in today's economic environment, identity fraud is a large and growing problem and while there are generally laws that protect non-business consumers (i.e., the individual customers 630, 632, or 634) from financial fraud, there generally are no such laws protecting business against the same fraud. As such, if business such as the FIs, retail entities, etc. are properly warned against the potential fraud of negotiable instruments coming from a specific individual, or business, it allows those business to avoid potential loses by refusing to accept negotiable instruments for DFAS 652 altered accounts and/or Payors.

### FES

In addition to MOGA 650 and DFAS 652, the FES 654 is another system and method that utilizes the information stored in the FAMS 600 database(s) 648, a centralized hub which can request, mine or scrap information from member FIs, plus public information gathered from other public sources such as credit reports, news organization, social media, Internet search engines, etc. In general, a problem that many FIs have is that some accounts and/or safety deposit boxes become old and inactive but they cannot close out the accounts without legally contacting the owner(s) of the account. Unfortunately, sometimes the owner(s) become unavailable or simply cannot be found by the FI. In these situations, associated FIs may send an escheat list 662, 664, or 666 of account holders that they are looking for to resolve issues with old inactive accounts (or safety deposit boxes). The FES 654 will then do a search for the Payors on the escheat lists based on searching the FAMS 600 database(s) 648 and other available information from external sources which may include requests to member FIs to search or provide information from their databases. If a hit is found, the FES 654 may either contact the Payor (in this case also the old or inactive account or safety deposit box holder) directly for the FI (and charge an associated fee) or send the contact information to the requesting FI for them to make contact with the missing Payor.

### MIFAS

Turning to the MIFAS 656, the MIFAS 656 may be a system and method that allows the FAMS 600 individual customers 630, 632, and 634 to have a mobile application on their mobile computers, mobile phones (such as smartphones), and/or mobile tablet devices. This application may have a graphical user interface (“GUI”) that interfaces with the FAMS 600 and shows the NSF items that the user needs to resolve, the payment required from the Payor, and the FAMS predetermined time period to make the payment.

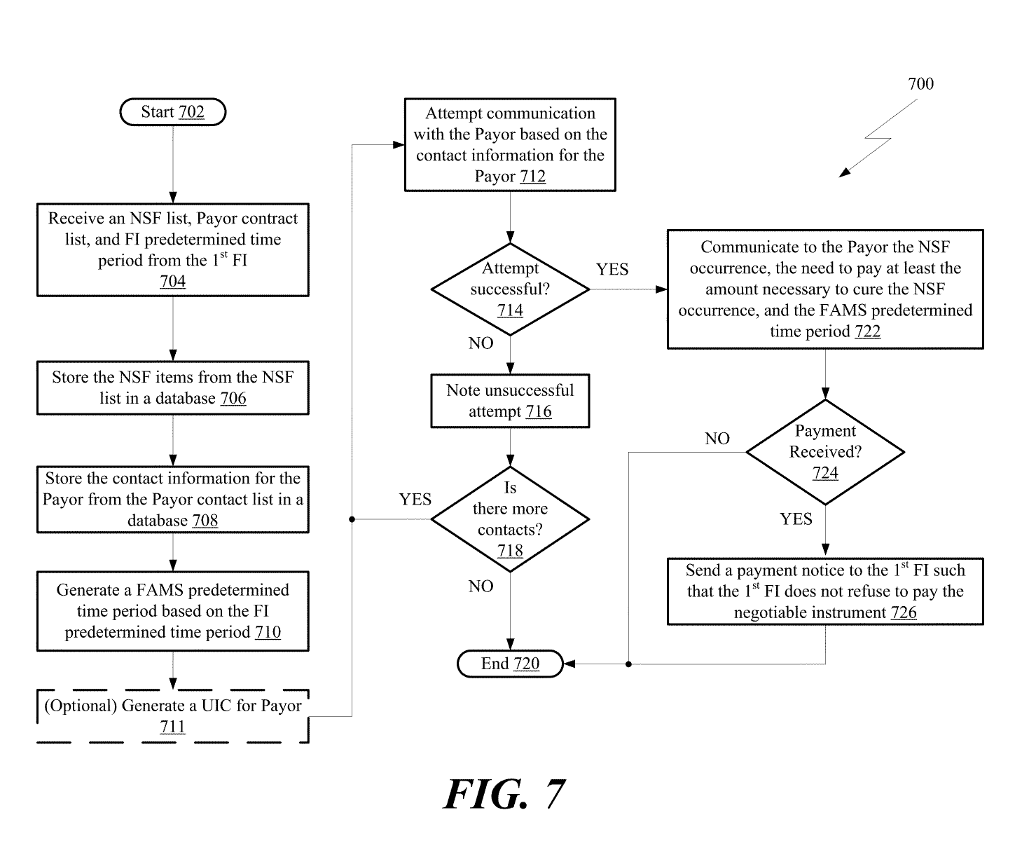

Turning to FIG. 7, a flowchart 700 of an example of an implementation of a method for reducing the occurrence of a non-payment event (by a 1st FI) of a negotiable instrument listing a monetary amount (where the negotiable instrument was generated by a Payor having a Payor account at the 1st FI) with the FAMS described in FIGS. 2, 3, and 6 is shown. The method starts 702 and, in step 704, the FAMS receives an NSF list, Payor contract list, and FI predetermined time period from the 1st FI. The FAMS then stores, in step 706, the NSF items from the NSF list in a database and also stores, in step 708, the contact information for the Payor from the Payor contact list in a database. The database may be the same or different, as shown in FIG. 3, as the database for the NSF items 330 and the database for Payors 332. The FAMS notes the time stamps in the NSF list that list a time and date for each NSF item that indicates when the 1st FI became discovered the NSF occurrence that corresponds to the NSF item. The FAMS then generates, in step 710, a FAMS predetermined time period based on the FI predetermined time period. The FAMS may also optionally generate a UIC for the Payor in step 711. The FAMS then extracts the contact information for the Payor from the Payor contact list and attempts to communicate, in step 712, with the Payor based on the contact information for the Payor. The attempt may include, for example, attempting to call the Payor using the listed home, work, or mobile telephone number. If the attempt is not successful, in decision step 714, the FAMS notes, in step 716, the unsuccessful attempt and stores it in a database with a time stamp that shows the date and time that the attempt was made. The FAMS then determines, in decision step 718, whether there is additional contact information that will allow the FAMS to attempt contact via a different method such as, for example, telephone numbers for sending texts, one or more email addresses, contact information for a 3rd party designee, etc. If there is additional contact information, the process will then repeat step 712 through decision step 718. If there is no more contact information and the FAMS has exhausted all possible contracts and no actual contact has been made, the process then ends 720 and the FAMS will not inform the 1st FI to not refuse to pay the negotiable instrument, which will result in the 1st FI refusing to pay the negotiable instrument or an NPD notice being sent by the 1st FI if the negotiable instrument had been paid or credited earlier.

If, instead, one of the forms of communication from the FAMS to the Payor (or 3rd party designee) is successful, the process continues to step 722 where the FAMS communicates with the Payor which may include communicating to the Payor the NSF occurrence, the need to pay at least the amount necessary to cure the NSF occurrence, and the FAMS predetermined time period in which the Payor must pay to prevent the 1st FI refusing to pay the negotiable instrument. The FAMS then time stamps the date and time that the communication was made with Payor or 3rd party designee and saves it in a database which may be, for example, the database for the NSF items. The FAMS then waits for the Payor's payment. If the payment is not received before the expiration of the FAMS predetermined time period the FAMS, in decision step 724, does not inform the 1st FI to not refuse payment of the negotiable instrument, which will result in the 1st FI refusing to pay the negotiable instrument or a NPD notice being sent by the 1st FI if the negotiable instrument had been paid or credited earlier.

If, instead, a payment is received from the Payor within the FAMS predetermined time period, the FAMS, in decision step 724, will proceed to step 726 where the FAMS will send a payment notice to the 1st FI such that the 1st FI does not refuse payment of the negotiable instrument or send a NPD notice. The negotiable instrument is then covered and the payment of the negotiable instrument proceeds through the normal process until it ends 720.

As an alternative to this process, it is appreciated that in steps 712 through 722, FAMS may attempt to communicate with the Payor using all the provided contact information, for example, the FAMS may determine that the Payor contact information includes a home telephone number, a mobile telephone number, a telephone number for receiving texts, an email address, and 3rd party contact information. In this example, the FAMS would attempt to contact every contact point provided whether or not any of the contact points works or is able to receive a message.

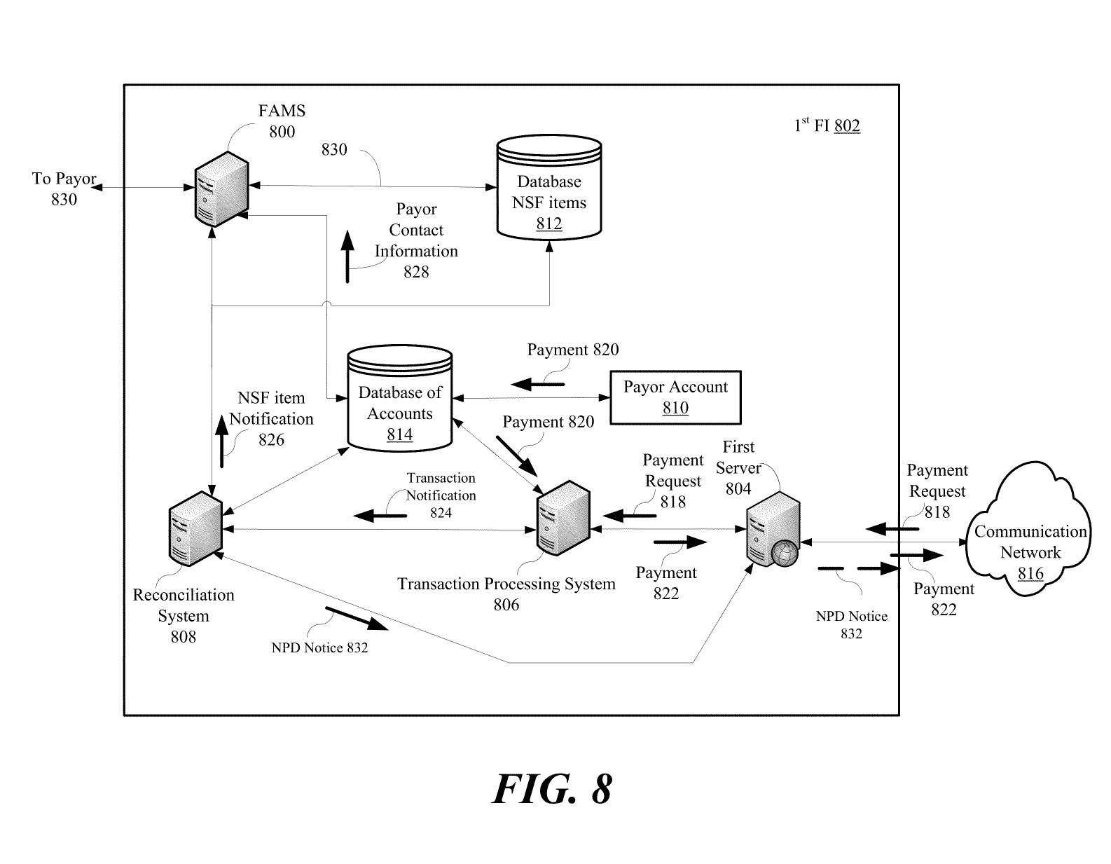

In FIG. 8, a block diagram of an example of another implementation of a FAMS 800 that reduces the effects of an NSF occurrence caused by a negotiable instrument that is utilized by a Payor to pay a Payee is shown. In this example, the FAMS 800 is part of 1st FI 802. The 1st FI 802 may include the FAMS 800, first server 804, transaction processing system 806, reconciliation system 808, Payor account 810, database on NSF items 812, and database of accounts 814. The 1st FI 802 may be in signal communication with the communication network 816, which may be the Internet. In this example, the first server 804 may be in signal communication with the transaction processing system 806, reconciliation system 808, and communication network 816. The transaction processing system 806 may be also in signal communication with the reconciliation system 808 and the database of accounts 814. The reconciliation system 808 may be also in signal communication with the FAMS 800 and the database of accounts 814. The database of accounts 814 may be also in signal communication with the FAMS 800 and the Payor account 810. The database of NSF items 812 may be also in signal communication with the FAMS 800.

In an example of operation, the Payor (not shown) generates and pays a Payee (not shown) with a negotiable instrument (not shown) having a monetary amount listed. The Payee deposits the negotiable instrument (i.e., a check) into his/her FI. The Payee FI then sends a request for payment 818 to the 1st FI 802. This request for payment 818 includes a substitute check image. The first server 804 receives the payment request 818 and passes it to the transaction processing system 806. The transaction processing system 806 then receives the payment request 818 determines the Payor account 810 from the substitute check (not shown) and the database of accounts 814. The transaction processing system 806 may then attempt to withdraw a payment amount 820 from the Payor account 810 to pay the monetary amount listed on the substitute check. This withdrawal may not happen immediately because it will need to be reconciled by the reconciliation system 808. However, the transaction processing system 806 may send a payment or credit 822 without reconciliation to the Payee's FI, which would be processed by the first server 804 and passed to the Payee's FI via the communication network 816. Once this has been done, the transaction processing system 806 may send a transaction notice 824 to the reconciliation system 808 to reconcile the payment and credit 822 with the funds available in the Payor account 810. In response, the reconciliation system 808 my process all transaction notices received and produce a reconciliation report that include any NSF occurrences. The NSF occurrences are noted as NSF items in a NSF list. This reconciliation process is typically run at night and the reports, including any NSF list, are ready to review by a FI manager in the morning of each day. In this example, if there are insufficient funds in the Payor account 810 to cover the monetary amount listed in the negotiable instrument, an NSF occurrence is noted by the reconciliation system 808. As a result, a NSF item notification 826 corresponding to the NSF occurrence may be sent to the FAMS 800. Once received by the FAMS 800, the FAMS may request and receive the Payor contact information 828 from the database of accounts 814 and may also access 830 the database of NSF items 812. The FAMS will them attempt to contact the Payor 830 via the different forms of contact provided by the database of accounts 814. If contact is made, the FAMS 800 will require that the Payor 830 make a payment to cure the NSF occurrence within a FI predetermined time period. If the Payor 830 does not make the payment or does not make it within the FI predetermined time period, reconciliation system then may generate a NPD notice 832 that may be send to the first server 804, which would pass it to Payee FI through communication network 816. In this example, since the FAMS 800 is part of the 1st FI 802, the FAMS 800 has access to all the database in the 1st FI 802.

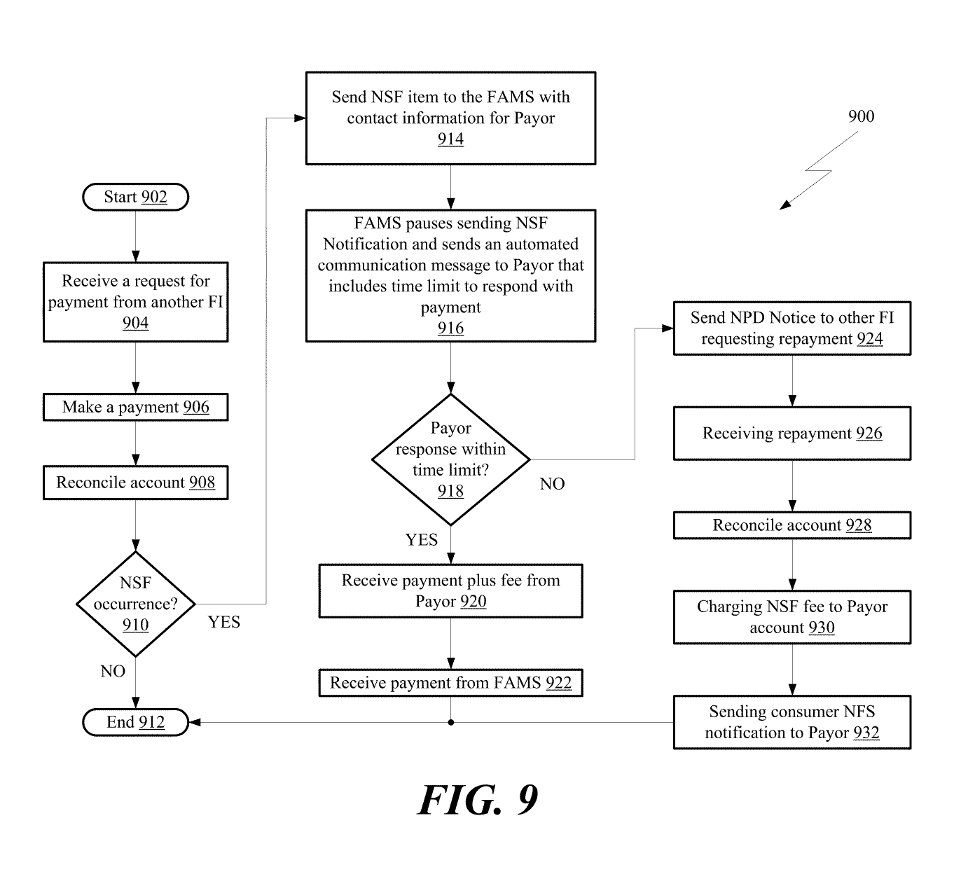

In FIG. 9, a flowchart 900 of an example of an implementation of a method for reducing the occurrence of a non-payment event (by a 1st FI) of a negotiable instrument listing a monetary amount (where the negotiable instrument was generated by a Payor having a Payor account at the 1st FI) with the FAMS described in FIG. 8 is shown. In this example, the FAMS is part of the 1st FI. The process starts 902 and the 1st FI receives, in step 904, a request for payment another FI on the negotiable instrument generated by the Payor. The FI may make the payment in step 906. The FI then reconciles, in step 908, the payments made throughout the day. In decision step 910, if a NSF occurrence does not happens in relationship with the negotiable instrument the process then ends 912 and the FI pays the negotiable instrument.

If, instead in decision step 910, an NSF occurrence does occur, the NSF occurrence is sent, in step 914, to the FAMS with the associated contact information for the Payor. In step 916, the FAMS pauses the sending of an NPD notice and attempts to send an automated communication message to the Payor that includes a FI predetermined time period to respond with a payment to cure the NSF occurrence. If the Payor responds in time and make the appropriate payment the decision step 918 sends the process to step 920. The appropriate payment may include the amount necessary to cure the NSF occurrence and a FAMS fee. The FAMS then receives the payment from the Payor, in step 920, and the payment is applied, in step 922, to reconcile the NSF occurrence in the 1st FI. The process then ends 912.

If, instead in decision step 918, the Payor does not respond or make a payment within the FI predetermined time period, the process continues to step 924. In step 924, the 1st FI sends the NPD notice to the other FI either refusing to pay the negotiable instrument or demanding for repayment of funds that were paid previously in relation to the negotiable instrument. The repayment is received, in step 926, and the accounts are then reconciled in step 928. The 1st FI then charges a NSF fee to the Payor account, in step 930, and sends, in step 932, a NFS notification to Payor. The process then ends 912.

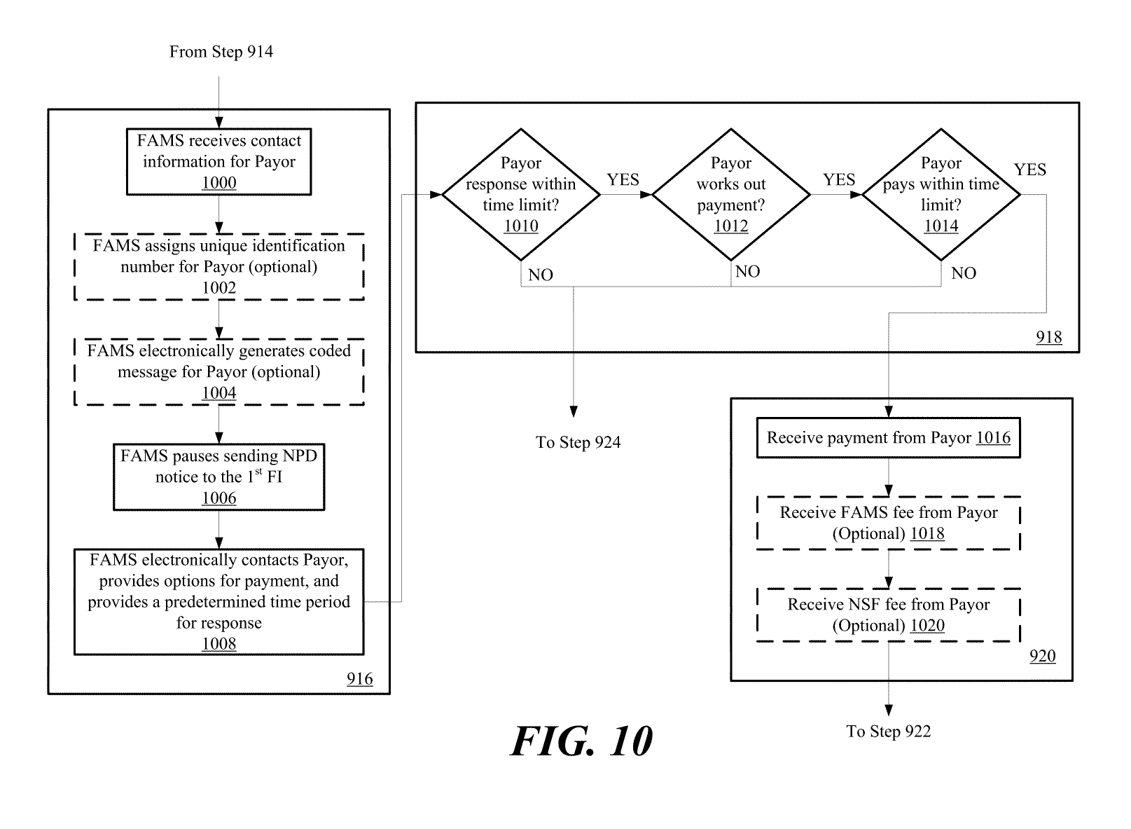

Turning to FIG. 10, sub-flowcharts of the flowchart shown in FIG. 9 is shown in accordance with the invention. The first sub-flowchart is of step 916 of FIG. 9 showing sub-steps 1000, 1002, 1004, 1006, and 1008. Similarly, the second sub-flowchart is of step 918 of FIG. 9 showing sub-decision steps 1010, 1012, and 1014 and the third sub-flowchart is of step 920 of FIG. 9 showing sub-steps 1016, 1018, and 1020. In the sub-flowchart for step 916, the FAMS receives contact information for Payor in sub-step 1000, then optionally assigns UIC number for Payor, in sub-step 1002, optionally electronically generates coded message for Payor, in step 1004, pause the sending of the NPD notice to the 1st FI, in sub-step 1006, and electronically contacts the Payor, provides options for payment, and provides a FI predetermined time period for response in step 1008.

In the sub-flowchart for step 918, FAMS determines if the Payor responses within the FI predetermined time period in decision step 1010. If the determination is no, the process continued to step 924. In, instead the determination is yes, the process continues to decision step 1012, where the FAMS determines if the Payor works out a payment. If the determination is no, the process again continues to step 924. If the answer is instead yes, the process continued to decision step 1014. In decision step 1014, the FAMS determines if the Payor makes the payment within the FI predetermined time period. If the answer is no, the process again continues to step 924; however, if the answer is yes, the process continues to step 920. In the sub-flowchart for step 920, FAMS receives the payment form the Payor in step 1016 and then optionally deducts either a FAMS fee, in step 1018, and/or a NSF fee in step 1020. The process then continues to step 922.

### 2. DFAS

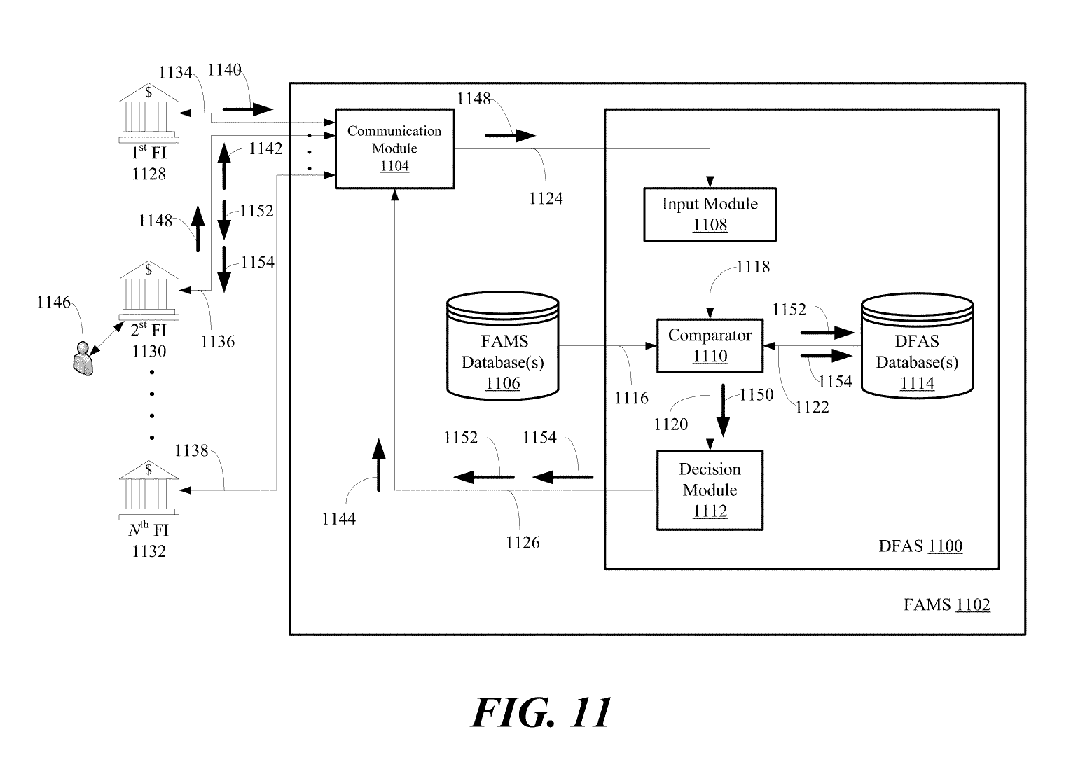

Turning back to FIG. 6, the FAMS 600 includes a DFAS 652 that is a system and method that utilizes the information stored in the FAMS 600 database(s) 648 and may be utilized to monitor the NSF items that are received by the different FIs against known Payor personal data. That monitoring may be at predetermined times, regular intervals or constantly. The DFAS 652 may be also a system and method that receives requests to investigate (“RTI”) from customers of the DFAS 652 and utilizes the information available in the FAMS 600 database(s) 648 and a DFAS database (not shown), which may include databases FAMS or DFAS have access to (not shown), to determine if there is potential fraud. Specifically, turning to FIG. 11, a block diagram of an example of an implementation of a DFAS 1100 is shown. In this example, the DFAS 1100 is part of the FAMS 1102. The FAMS 1102 may include all of the systems, modules, components, and/or devices described in the FAMS 300 shown in FIG. 3. For convenience, only a communication module 1104 and FAMS database(s) 1106 are shown but it is appreciated that all other modules described in FIG. 3 may also be present in the FAMS 1102 even though not explicitly shown in the figure. In this example, the FAMS database(s) 1106 may include the database of NSF items 330, Payor database 332, and other databases. The DFAS 1100 may include an input module 1108, comparator 1110, decision module 1112, and DFAS database(s) 1114 where the DFAS database(s) 1114 may be one or more databases.

Those of ordinary skill in the art will recognize that the DFAS 1100 does not require the complete FAMS 1102 or all process steps to monitor potential fraud. Rather, the DFAS 1100 compares the RTI against NSF items available, received, or collected by the DFAS 1100 to identify patterns or anomalies that are predictive of fraud.

In this example, the comparator 1110 may be in signal communication with FAMS database(s) 1106, (alternatively it may be in contact with one or more non FAMS databases which contain records of NSF events that are also connected to a specific identity (person or entity)), input module 1108, comparator 1110, decision module 1112, and DFAS database(s) 1114 via signal paths 1116, 1118, 1120, and 1122, respectively. The communication module 1104 may also be in signal communication with the input module 1108 and decision module 1112 via signal paths 1124 and 1126, respectively. The communication module 1104 may be in signal communication with a plurality of FIs of which, for convenience, only three with be shown, however, it is appreciated that there could be many more FIs. Specifically, the communication module 1104 may be in signal communication with a 1st FI 1128, 2nd FI 1130, and Nth FI 1130 via signal paths 1132, 1134, and 1136, respectively. Again, it is appreciated that “N” represent the number of FIs.

In one example of operation, the DFAS 1100 may be utilized to monitor the NSF items that are received by the different FIs against known Payor personal data (i.e., Payor identity). Specifically, if both 1st FI 1128 and 2nd FI 1130 produce NSF items 1140 and 1142 and both of these items appear to be associated with the same Payor personal data (such as, for example, social security numbers, employer identification number “EIN,” driver's license numbers, home addresses, telephone numbers, etc.), there is a chance Payor's personal data (i.e., the Payor's identity) has been compromised and that someone has obtained Payor's personal data is fraudulently generating negotiable instruments attributed to Payor using the Payor's personal data. In this example, by checking the information provided by the 1st FI 1128 and 2nd FI 1130, in relation to the NSF items 1140 and 1142, against the FAMS database(s) 1106 and/or the DFAS database(s) 1114, the DFAS 1100 may be able to determine if one or both of the NSF items 1140 and 1142 are the results of fraud or if an identity theft is suspected. If there is fraud, or compromised identity, the DFAS 1100 may then produce a fraud alert 1144 that may be sent to one or more associated FIs (which may be subscribers) and vendors (which are utilizing DFAS 1100 to pro-actively guard against fraud and identity theft) that informs these entities to either raise their level of security with respect to this Payor and/or not accept checks from this Payor until the fraud alert has been resolved.

In some instance the historical information from past RTIs in the FAMS and/or DFAS databases is compared against the RTI for a predetermined period of time. A non-limiting list of time periods include but are not limited to at least about 12 hours, at least about 24 hours, at least about 48 hour, at least about 72 hours, at least about one week and at least about one month.

In the case of Payor's that legitimately have different accounts at different FIs, this information should already be in the FAMS database(s) 1106 and as such should not be a problem. However, if associated data such as address, telephone numbers, email, mobile phone, driver's license, passport, image, or other biometric data (fingerprint, voice, face, DNA, hand print and the like) is different, then a warning may be appropriate. An advantage of the DFAS 1100 is that in today's economic environment, identity fraud is a large and growing problem and while there are generally laws that protect non-business consumers from financial fraud, there generally are no such law protecting business against the same fraud. As such, if business such as the FIs, retail entities, etc. are properly warned against the potential fraud of negotiable instruments coming from a specific individual, or business, it allows those business to avoid potential loses by refusing to accept negotiable instruments flagged by the DFAS 1100. This is an advantage because in today's financial industry and others that either extend credit and/or sell goods utilize traditional fraud systems that are typically identity theft and fraud systems that tend to be an exercise in chasing a bad actor. These known systems tend to be reactive instead of pro-active. The DFAS 1100 described in pro-active.

In another example of operation, the DFAS 1100 may be utilized by customer FIs or other business entities as a way of verifying potential customers of the FI or business entities. Specifically, if the 2nd FI 1130 is approached by potential customer 1146 attempting to open an account at the 2nd FI 1130, the 2nd FI 1130 may send an RTI 1148 to the DFAS 1100 to investigate the potential customer 1146 for potential fraud. It is appreciated that the potential customer 1146 may be an individual or business entity. The RTI 1148 is received via the communication module 1104 of the FAMS 1102 and sent to the input module 1108 of the DFAS 1100. The RTI 1148 may include all the personal identification information (i.e., contact and identity information) for the potential customer 1146 that the 2nd FI 1130 possesses. The DFAS 1100 then compares the RTI 1148 against the data in both the FAMS database(s) 1106 and DFAS database(s) 1114 in the comparator 1110. The results of the comparisons 1150 are passed to the decision module 1112, where the decision module 1112 may include rule and decision engines, state machines, a processor with associated decision software, threshold circuitry, etc. The decision module 1112 then determines whether the comparator 1110 can confirm the identity potential customer 1146 as being secure or not. Based on this determination, the decision module 1112 determines whether to issue a fraud alert 1152 or a CLEAR response 1154, both of which are passed through the communication module 1104 to the 2nd FI 1130. If the decision module 1112 determines that the identity of the potential customer 1146 is secure (i.e., there are no flags, alarm alerts, or other anomalies) the decision module 1112 will issue the CLEAR response 1154. If, on the other hand, the decision module 1112 determines that the identity of the potential customer 1146 is not secure (i.e., the potential customer appears with variations in the database records) the decision module 1112 will issue the fraud alert 1152. A copy of the CLEAR response 1154 and fraud alert 1152 with all the associated data may be stored in the DFAS database(s) 1114 for future comparisons. In this example, the fraud alert 1152 may not be a “true fraud” alert in that it may only indicate that there are anomalies associated with the potential customer 1146 such as, for example, inconsistent address, multiple addresses, inconsistent phone number, multiple phone numbers, disconnected phone, bounced email, multiple email addresses, multiple addresses, inconsistent spouse information, multiple bank accounts, past fraudulent activities with same or similar names, image, voice, fingerprint, facial recognition, other biometric information. As a result, the fraud alert 1152 may include different levels of concern based on the anomalies found that may range, for example, at 1 to 5, where level one is the lowest concern and 5 is the highest.

In this example, the DFAS 1100 may compile its own data in the DFAS database(s) 1114 that is separate from the FAMS database(s) 1106 but includes information from the FAMS database(s) 1106. Additionally, the DFAS 1100 may include a public information module (not shown) that is configured to search and data mine public sources and records as part of it comparison process with the comparator 1110.

The DFAS 1100 may also proactively send notifications (i.e., fraud alerts) to additional FIs (such as, for example, 1st FI 1128 through the Nth FI 1130. These additional FIs may be FIs that have previously engaged the DFAS 1100 to perform an RTI on a potential customer. In this fashion a FI that previously request the RTI may update incorrect records, add additional data and more preferably can flag an account, person, or entity that has been identified by the DFAS 1100 as having anomalous results. The same is true of entities that are subscribers of the DFAS 1100 (or have provided data to the DFAS 1100 in the past) which may include leasing companies, lessors of real property or other entities.

It is known that bank fraud related to identity theft, in particular, relies on a bad acting individual to leverage a false identity in a short period of time. Scenarios include the bad actor opening a bank account and using a stolen identity with false contact information to hide the account from the person whose identity has been compromised. The DFAS 1100 by having access to data on individuals and entities from prior RTI operations and other databases can flag an anomalous set of information for the bank dynamically, in near real time, potentially before a bad actor is able to steal money via an overdraft on the account.

Another scenario is the bad actor opening multiple bank accounts at different FIs and utilizing overdraft mechanisms to cover NSF checks. Because the FIs (being stolen from) will require several days under the traditional system to even send out the NSF notice and then will spend additional weeks to determine the account needs to be closed. Therefore, during the short period during which the greatest damage may occur, there is no reporting by any FI to traditional agglomerators of records of non-performing bank customers. As such, even a FI that subscribes to a traditional system of checking will be vulnerable during the short time frame these bad actors tend to act during. Accordingly, under the traditional systems, bad actor could simultaneously open bank accounts at several institutions write a series of bad check at each bank and utilize the overdraft mechanism to cover the checks. As described earlier, this type of activity would be flagged by the DFAS 1100 issuing the fraud alert 1144. In this example, the fraud alert 1144 may report to subscribing FIs or other entities as soon as an anomaly such as an individual (or entity) opening multiple bank accounts at multiple institutions in a specified time frame.

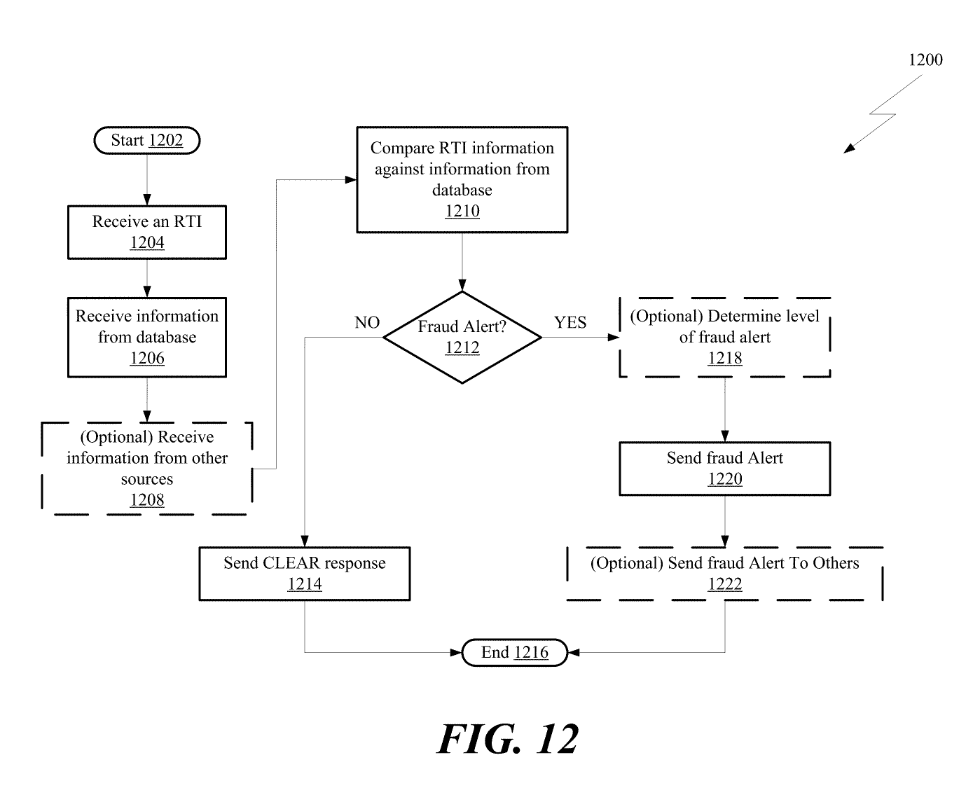

Turning to FIG. 12, a flowchart 1200 is shown of an example of an implementation of a method for receiving RTIs from customers of the DFAS and utilizing the information available to the DFAS to determine if there is any potential fraud. The process starts 1202 by the DFAS receiving an RTI, in step 1204, from a 1st FI. The RTI will request that the DFAS check a potential customer (i.e., a person or entity) via their social security number or other identification number (“ID”), Tax ID number, or Employer ID number, date of birth, business name and other identifiers for consistency of address, telephone, email and other personal information such as a fingerprint, retina image, or other biometric data and the like. In this example, the RTI will include the identification information that the 1st FI has received from the potential customer.

The DFAS then queries and receives, in step 1206, information from the DFAS available databases. The DFAS available databases may include the DFAS database (or databases) 1114 and the FAMS database (or database) 806, which may include the database of NSF items 330 and database of Payors 332. The DFAS may optionally also receive, in step 1208, information for other sources such as, for example, publically available sources. The DFAS then compares, in step 1210, the RTI provided information against the information in the available databases and optional information from other sources. The results are passed to a decision engine of the DFAS. The DFAS then determines, in decision step 1212, whether there are any anomalies. If there are no anomalies the DFAS sends, in step 1214, a CLEAR response to the 1st FI and the process ends 1216.

If, on the other hand, the DFAS does determine, in decision step 1212, that are some anomalies, the process then continues to optional step 1218. In optional step 1218, the DFAS determines types of anomalies and establishes a level for the fraud alert that will be generated. The fraud alert is then generated and sent, in step 1220, and the DFAS may optionally also send this fraud alert to other subscriber FI or other entities, in step 1222. The process then ends in step 1216.

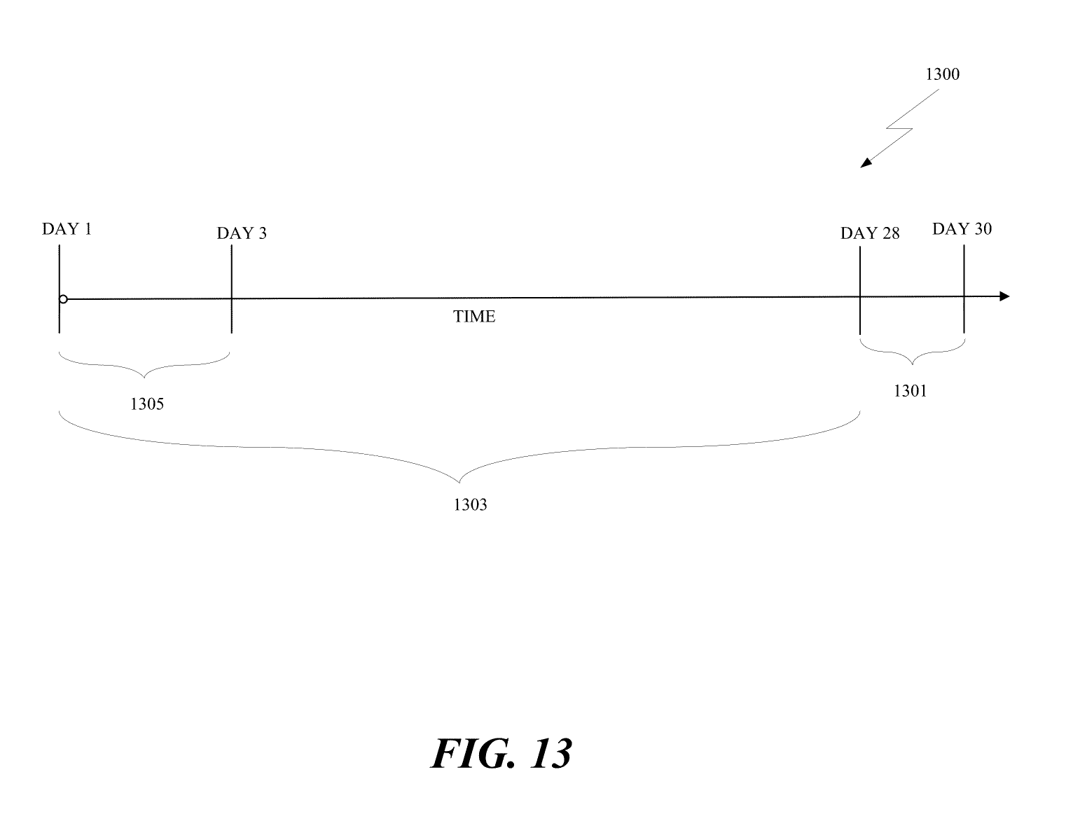

Turning now to FIG. 13, a time line 1300 is illustrated as a comparison of DFAS pro-active fraud watch to traditional methods and systems. Traditionally, FI reporting of accounts that are being closed due to non-responsive/non-performing account holders by FIs to traditional agglomerators of records of non-performing bank customers are after 28 to 30 days (i.e., time period one 1301). However, that allows at least 27 days (i.e., time period two 1303) during which a bad actor may operate to exploit an identity theft and steal from persons, business and FIs via taking the funds legitimately placed in the account by the legitimate account holder and via leveraging any overdraft offered by the FIs and corresponding to such accounts. With the DFAS monitoring the situation, this time period may be reduced by a third (time period 1305), where the DFAS can monitor for anomalies in NSF items wherein the identity of the Payor (i.e., social security numbers, EIN and the like) does not correspond to the contact or personal information associated with the accounts at each FI reporting the NSF items. Preferable the DFAS monitors a time (time period 1303) between the first NSF item and the time when traditional agglomerators of non-performing account reports to FIs. Additionally, the DFAS may monitor during the one-third time period (time period 1305) covering the zero to three days from the first NSF item because this is when FIs and the account holder are most vulnerable to attack.

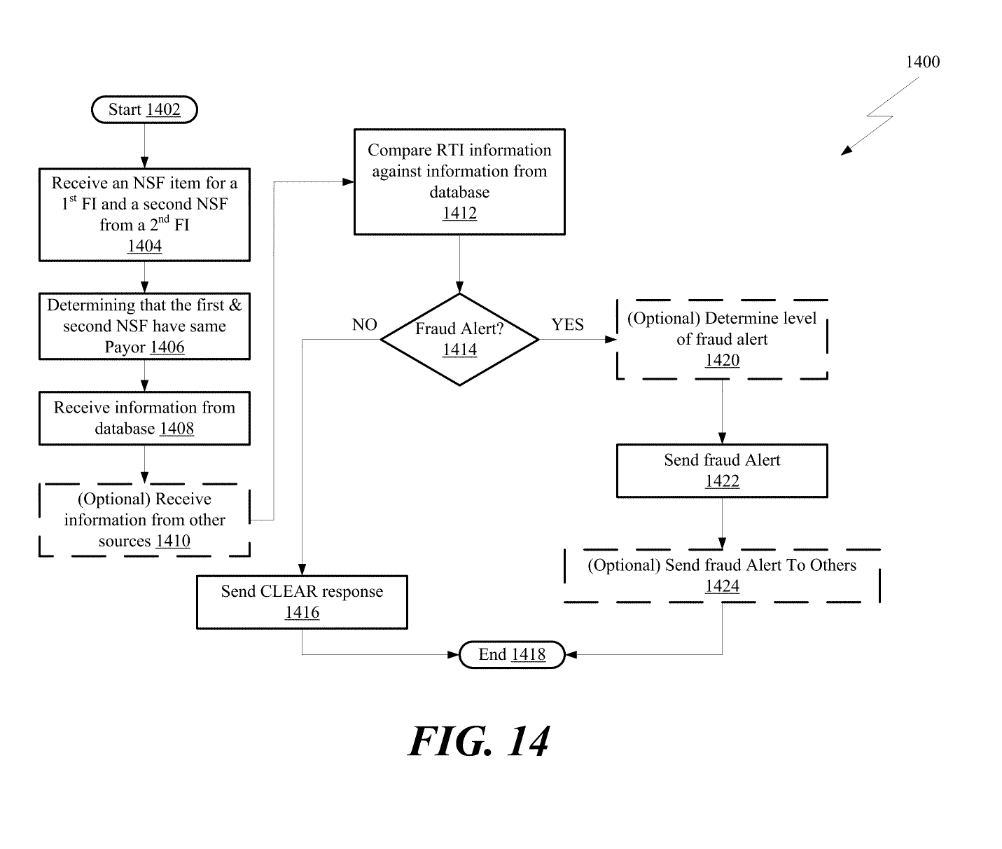

In FIG. 14, a flowchart 1400 is shown of an example of an implementation of a method for monitoring NSF items (from different FIs against the same Payor) that are provided to the FAMS with the DFAS and utilizing the information available to the DFAS to determine if there is any potential fraud. The process starts 1402 by the FAMS receiving a first NSF item for a 1st FI and a second NSF item for a 2nd FI in step 1404. Either the FAMS or DFAS then determines that that the first NSF item and second NSF item are identified as being caused by the same Payor in step 1406.

The DFAS then queries and receives, in step 1408, information from the DFAS available databases. The DFAS available databases may include the DFAS database (or databases) 1414 and the FAMS database (or database) 1106, which may include the database of NSF items 330 and database of Payors 332. The DFAS may optionally also receive, in step 1410, information for other sources such as, for example, publically available sources. The DFAS then compares, in step 1412, the first NSF and second NSF provided information against the information in the available databases and optional information from other sources. The results are passed to a decision engine of the DFAS. The DFAS then determines, in decision step 1414, whether there are any anomalies. If there are no anomalies the DFAS sends, in step 1416, a CLEAR response to the 1st FI and the process ends 1418.

If, on the other hand, the DFAS does determine, in decision step 1414, that are some anomalies, the process then continues to optional step 1420. In optional step 1420, the DFAS determines types of anomalies and establishes a level for the fraud alert that will be generated. The fraud alert is then generated and sent, in step 1422, and the DFAS may optionally also send this fraud alert to other subscriber FI or other entities, in step 1424. The process then ends in step 1418.

### 3. MOGA

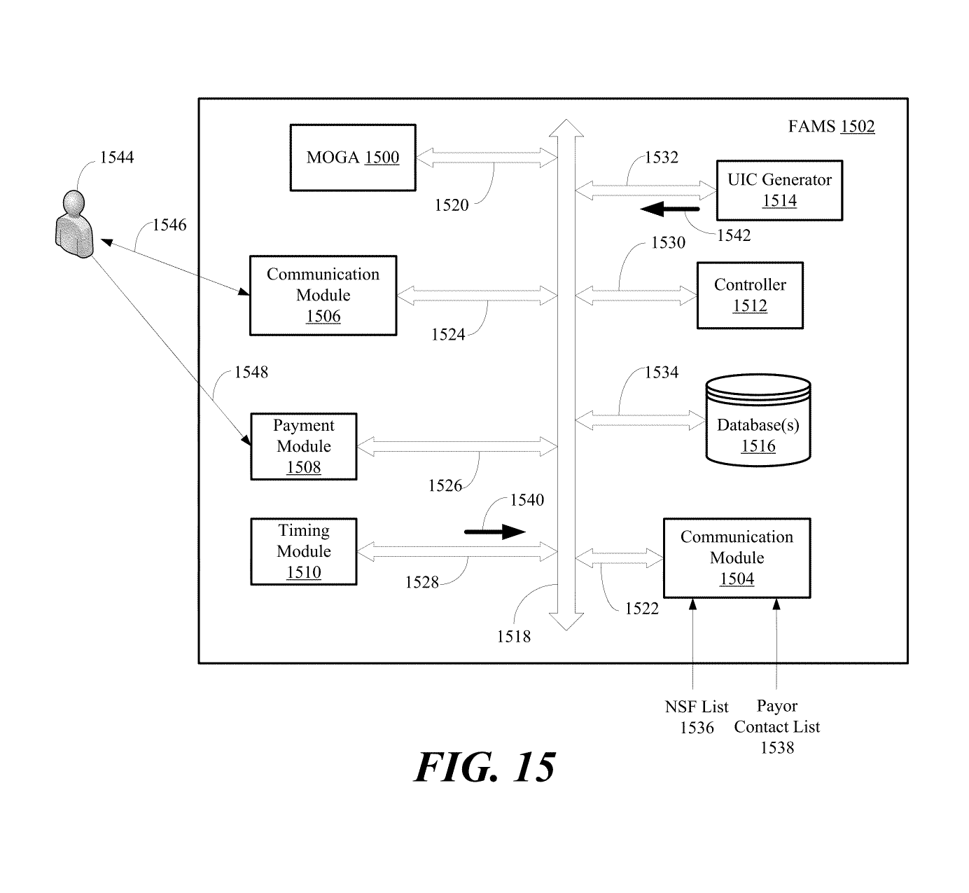

Turning back to FIG. 6, as described earlier, the MOGA 650 may be utilized to create a historic rating of how a Payor responds to the FAMS 600 and resolves NSF occurrences on the Payor accounts. Turning forward to FIG. 15, a block diagram of an example of an implementation of a MOGA 1500 within a FAMS 1502 is shown. Similar to FIG. 6, the FAMS 1502 may include the MOGA 1500, a first communication module 1504, a second communication module 1506, payment module 1508, timing module 1510, controller 1512, UIC generator 1514, database(s) 1516, and bus connection (or network) 1518. The bus 1518 may be a signal path such as, for example, an internal bus within a computer (assuming that the FAMS 1502 is a single computer system) or other type of network bus such as, for example, an Ethernet or Internet connection if the FAMS 1502 consists of multiple computer systems networked together. In this example, the bus 1518 is in signal communication with the MOGA 1500, first communication module 1504, second communication module 1506, payment module 1508, timing module 1510, controller 1512, UIC generator 1514, and database(s) 1516 via signal paths 1520, 1522, 1524, 1526, 1528, 1530, 1532, and 1534, respectively.

In some instances, MOGA provides a way into the credit market to some underbanked individuals or entities. The MOGA generated metric score is a new banking/credit/action metric that provides a new system and method that receives, collects and/or monitors actions of a Payor. MOGA applies rules and/or decision engines to the data and produces a value for the actions and combinations of actions over time, thereby producing a good (or bad) actions metric that may also be used as a credit worthiness metric or as a part of a metric for determining creditworthiness. In other words, actions can speak louder than words.

In this example, MOGA 1500 is configured to receive information about NSF items, corresponding Payors, and the interactions between the Payors and the FAMS 1502. Specifically, in operation, MOGA 1500 receives the receipt of an NSF list 1536 and Payor contact list 1538, the FAMS predetermined time period 1540 produced by the timing module 1510, the generated UIC 1542 for a NSF item on the NSF list and the corresponding Payor 1544, the communications 1546 between the FAMS 1502 and the Payor 1544, and payments 1548 from the Payor 1544. In some instances MOGA 1500 may monitor the process. The MOGA 1500 may also receive information about, or in some instances monitor, the communications 1546 between the FAMS 1502 and a 3^{rd} party designee (not shown) of the Payor 1544, and payments 1548 made from the 3^{rd} party designee of the Payor 1544.

Those of ordinary skill in the art will recognize that the payment data concerning when or if an NSF item was paid or not paid by a Payor and whether the item was sent back to the Payee as not accepted for deposit may alternatively be collected from one or more FIs, processed with aspects of the systems and methods disclosed herein and the resulting scoring would be within the scope of this invention.

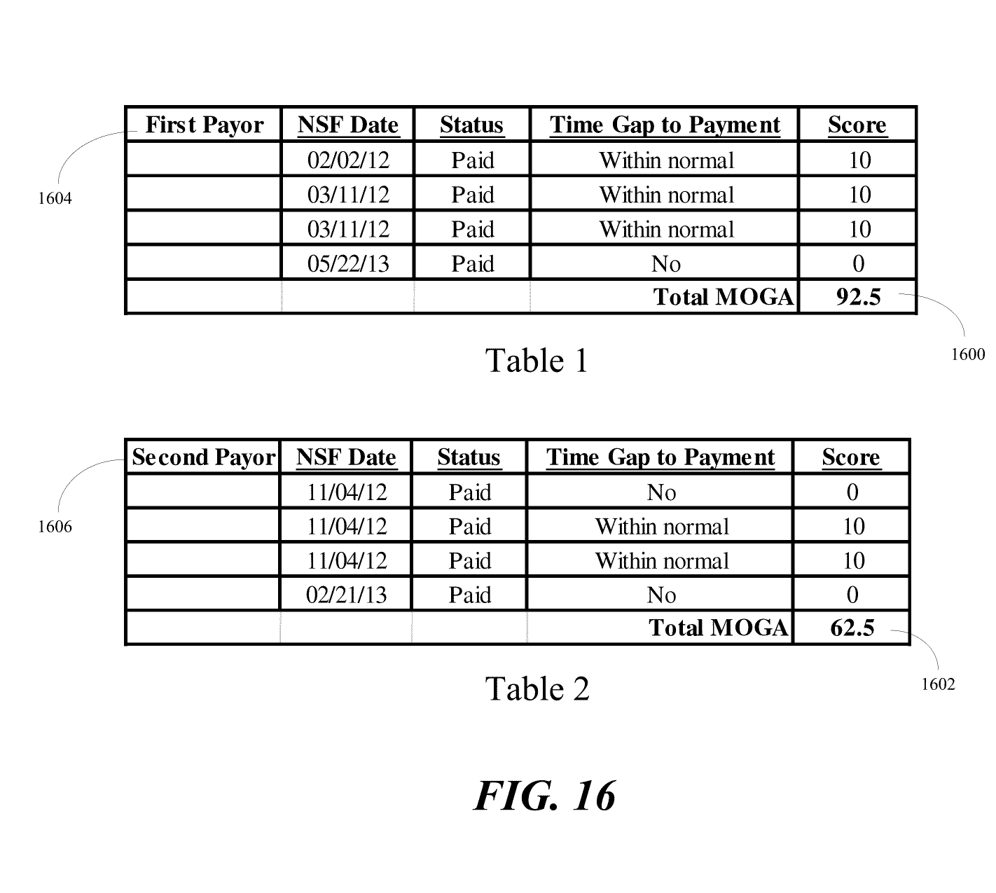

The MOGA 1500 may be utilized to create a historic rating of how Payor 1544 resolves NSF occurrences on the Payor accounts. In general, if the Payor 1544 is timely in resolving the NSF occurrences and, therefore, does not cause the respective Payor FIs to issue and/or send NPD notices to other FIs on their negotiable instruments that have caused the corresponding NSF occurrences, their MOGA 1500 generated metric scores will reflect how the Payor acted when confronted with a financial problem, and a good action (such as timely resolution of the NSF) will equate to a higher MOGA number or score. If, on the other hand, Payor 1544 is not timely in resolving the NSF occurrences and, therefore, does cause the respective Payor FIs to issue and/or send NPD notices to other FIs on their negotiable instruments that have caused the corresponding NSF occurrences, the MOGA 1500 generated metric scores will reflect the lack of good action and will be lower. As described earlier, these MOGA 1500 generated metric scores may also take into account the number of NSF occurrences caused by Payor 1544 and the amounts that cause the NSF occurrences. These MOGA 1500 generated metric scores may then be utilized by other FAMS 1502 customers to determine if they will accept a negotiable instrument from the Payor 1544 based on the MOGA 1500 generated metric score. Such FAMS 1502 customers, user or subscribers, may also utilize MOGA 1500 as a replacement for or an augmentation of a traditional FICO™ score or other known credit scoring metric. This use would apply to areas of extending credit, terms of contracts, performing services, the leasing of goods or property, etc. As stated previously, this may include individual customers and business entities that are FAMS 1502 customers. As an example, tables 1 and 2 in FIG. 16 show a comparison of MOGA 1500 metric generated scores 1600 and 1602 for two Payors (first Payor 1604 and second Payor 1606) based on four NSF occurrences to each Payor. The tables show that the first Payor 1604 has a higher score than the second Payor 1606 (such as, for example, the first Payor 1604 has a total MOGA score 1600 of 92.5 versus the second Payor 1606 has a total MOGA score 1602 of 62.5). The first Payor's 1604 MOGA total score 1600 is based on four NSF occurrences on three separate dates (Feb. 2, 2012, Mar. 11, 2012, and May 22, 2013) that were all paid. Three of the payments were made within the FAMS predetermined time period and one was not. The second Payor's 1606 MOGA total score 1602 is also based on four NSF occurrences; however, these four NSF occurrence happened on two separate dates (Nov. 4, 2012 and Feb. 21, 2013) that were all paid. In this example, two of the payments were made within the FAMS predetermined time period and two were not.

The tables 1 and 2 are not intended to be an exclusive list of MOGA score parameters; the scoring system may be weighted on a multitude of criteria including but not limited to the Payee of the NSF item, the amount of the NSF item, whether the NSF item was the result of a dispute (intentionally cancelled instrument), whether the NSF event was connected to a deposit received by Payor being uncollected at the time the NSF occurred. Other criteria may include was the NSF payment to a municipality or governmental agency, or was it to a leasing entity. Additional criteria may also include were there multiple NSF events on the same day—a Payor who resolves a multitude of NSF events on a single day may be scored differently than a Payor who resolves the some number of NSF events in a longer period. Other factors may include a Payor who has established an Account with FAMS to expedite the payment of an NSF event. The action of having a FAMS account as a preparation for addressing a future NSF event may be considered in scoring. The frequency that a Payor uses overdrafts to cover an NSF occurrence may also be considered in weighing the actions and determining a score. The raw data concerning events, timing and responses is transformed by MOGA engines utilizing algorithms into a value which can be represented as a measure against a scale. A heuristic system may be utilized to forecast future actions as at least a part of the score.

It is appreciated by those skilled in the art that in this example, a MOGA 1500 metric credit score is an objective metric showing specific conduct in solving (or not solving) a concrete financial problem. A provider of goods or services such as a lessor or lender will benefit from being able to assess the payment character of a Payor customer. In general, a customer that has many NSF occurrences but manages to cover and pay these NSF occurrences before they are returned is different than a customer who has NSF occurrences and is haphazard or less successful at paying them in a timely and consistent fashion.

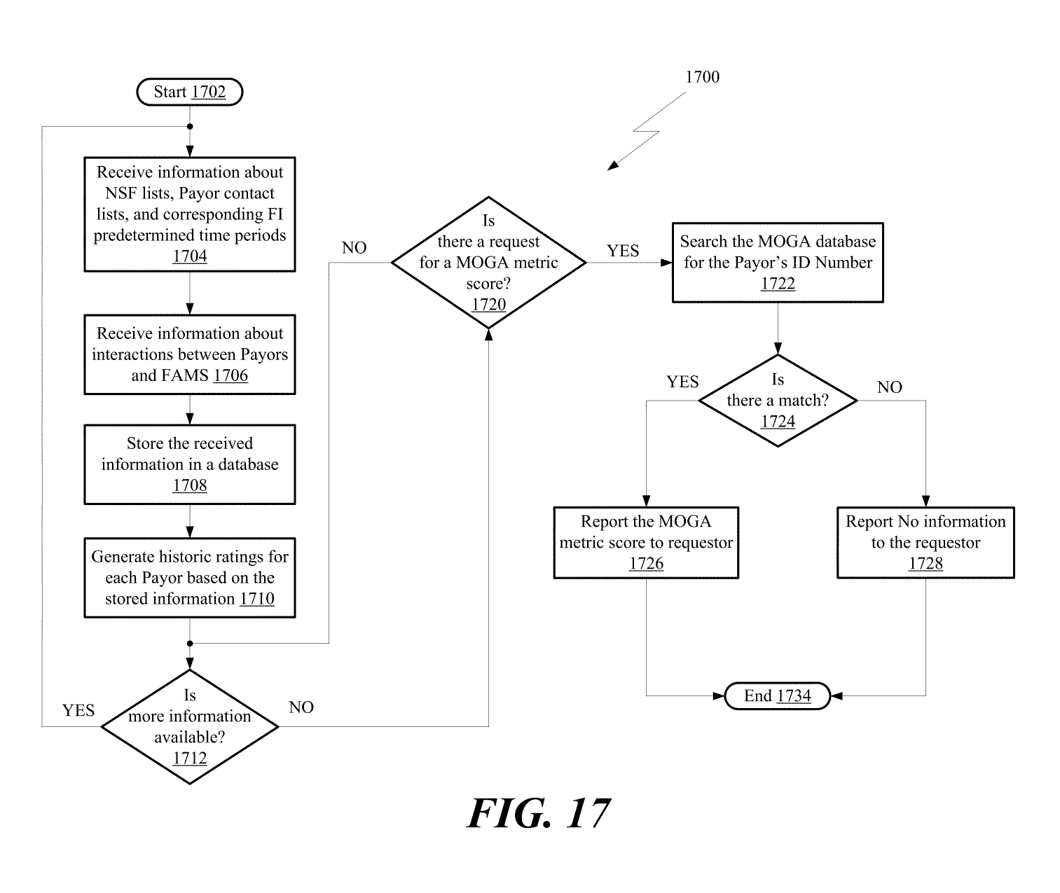

Turning to FIG. 17, a flowchart 1700 of an example of an implementation of a method for generating a MOGA generated metric score is shown. The method starts 1702 and, in step 1704, the MOGA receives information about one or more NSF lists, Payor contract lists, and corresponding FI predetermined time periods from a plurality of FAMs. In step 1706, the MOGA receives additional information about interactions between Payors and the plurality of FAMs, which information may include the communications between the Payor 304 and the FAMS 300 (as shown in FIG. 3), as well as the communications between a 3^{rd} party designee 378 and FAMS 300. The received information is then stored in a database by the MOGA in step 1708. In step 1710, the MOGA generates historic ratings for each Payor identified in the collection information by building tables, examples of which are shown in FIG. 16, over time as additional information is acquired. In step 1710, generating the historic ratings may include the weighting of multiple criteria as explained in more detail above.

In decision step 1712, the MOGA determines if additional information is available, and if there is additional contact information, the process will then repeat steps 1704 through decision step 1712, thus over time, acquiring more and more information upon which the MOGA generated metric scores can be generated. In essence, the MOGA may be continually monitoring the receipt of incoming information. If there is no information immediately available to be processed, then the process may proceed to step 1720, where it monitors requests for MOGA generated metric scores. If the MOGA receives a request for a MOGA generated metric score for a particular Payor, then in step 1722, the MOGA database is searched to see if there is a MOGA generated metric score in the database for the Payor. If there is, the decision step 1724 sends the process to step 1726 and in step 1726, the process reports the MOGA generated metric score to the requestor. If there is no match, the decision step 1724 sends the process to step 1728 and in step 1728, the process reports “no information on Payor” to the requestor.

In both cases, the process then ends 1734. However, it is understood that the process may also continue to either step 1712 or step 1720 to continue monitoring for the receipt of additional information or another request for a MOGA generated metric score, respectively.

### 4. MIFAS

Turning to the MIFAS 656, the MIFAS 656 may be a system and method that allows the FAMS 600 individual customers 630, 632, and 634 to have a mobile application (“MobileApp”) on their mobile device (such as, for example, a mobile computer, mobile phone (such as a smartphone), and/or mobile tablet device). This MobileApp may have a GUI that interfaces with the MIFAS 656 of the FAMS 600 and shows the NSF items that the Payor needs to resolve, the payment required from the Payor, and the FAMS predetermined time period to make the payment. The MobileApp may be a software program that is capable of interfacing and communicating with the software/hardware systems within the FAMS 600. In general, the MobileApp is capable of communicating with the MIFAS 656 through numerous types of networks that include, for example, the Internet, PCS networks, cellular telephone networks, landline telephone networks, proprietary networks, secure networks, etc.

In the case of a smart telephone or tablet, the MobileApp may be a software program that may be downloaded from an application store (“App” store) (such as, for example, the App stores operated by Apple Inc. of Cupertino, Calif., Microsoft Corporation of Redmond, Wash., Google Inc., of Mountain View, Calif., Samsung Electronics Co., Ltd, of South Korean, BlackBerry Limited, of Waterloo, Canada, etc.) and installed in the mobile device. The MobileApp may also be obtained directly from the FAMS 600 by accessing a website operated by the FAMS 600 that has a downloadable hyperlink for the MobileApp.

Once installed in the mobile device, the MobileApp may be initialized by the user of the mobile device (i.e., the Payor) to operate with the MIFAS 656. The user may sign into a previously established personal account on the FAMS 600 (if the user is a FAMS customer) or he/she may establish an account via the MobileApp. Once initialized, the MobileApp may be set up to provide the user with reminder alerts related to their potential NSF occurrences and to communicate with the FAMS 600 if an NSF occurrence actually occurs. For security purposes the MIFAS 656 may include separate contact server computer systems that are external to the FAMS 600 servers so as to add layers of firewalled security before allowing the MobileApp to communicate with the MIFAS 656. Additionally, the MobileApp may also be installed in a mobile device of a 3^{rd} party designee of the Payor to allow the 3^{rd} party designee to receive the reminders that will be sent to the Payor and allow the 3^{rd} party designee to make payments for the Payor.

The MobileApp allows customers (i.e., Payors) of the FAMS organization (whether a third-party or the actual FI of the respective customer) to receive personal, private, and secure communications from the FAMS 600, via the MIFAS 656, without having to go through the previously described attempts at contacting the customer such as, for example, robo-calling the Payor's home, work with either pre-recorded or computer generated voice messages, and/or mobile telephone numbers, generating a computer message that can be utilized by a call center person to call and potentially talk to the Payor, sending computer generated text messages to Payor's mobile, sending computer generated emails to the Payor's personal and/or work emails. Since the customer will have to verify himself/herself to the FAMS 600 when initializing and setting up the MobileApp, the MobileApp allows for a more secure way of communicating between the customer and the FAMS 600 if an NSF occurrence actually happens. This same reasoning applies to the 3^{rd} party designee if they also install the MobileApp on to their mobile device.

In an example of operation, the MobileApp may be placed in an active state on a mobile device of a Payor. If an NSF event happens, the FAMS 600 determines that the Payor is a customer of the FAMS 600 and, via the MIFAS 656, determines that the Payor has a mobile device with the installed MobileApp. At this point, the FAMS 600, via the MIFAS 656, sends the information of an NSF event to the MobileApp on the mobile device of the Payor that may include an alert or alarm that will notify the Payor that MobileApp needs to be attended to because of important information. As an example, a window, icon, or other graphical warning may flash on screen plus the MobileApp may cause the mobile device to emit an alarm sound and/or vibrate. The window, icon, or other graphical warning may include, optionally, a warning message with a timer or a coded message that requires the Payor to log into the MobileApp to see the coded message.

Once the Payor has logged into the MobileApp, the MobileApp may present the Payor with multiple options for resolving the NSF occurrence within the required FAMS predetermined time period. Additionally, the MobileApp may include a location, mapping, and/or navigation module that allows the MobileApp to determine the Payor's location and the distance and directions to the nearest FAMS affiliated locations that accept in person payments from the Payor.

In addition to the MobileApp, the MIFAS 656 may also be configured with remote software similar to the MobileApp that is configured to run on non-mobile devices such as, for example, non-mobile computers, smart television devices, digital media players (such as, for example, digital media players produced by Apple, Google, Western Digital Corporation of Irvine, Calif., Roku, Inc. of Saratoga, Calif., etc.), or smart gaming consoles (such as devices produced by Nintendo Co., Ltd of Kyoto, Japan, Sony Corporation, of Tokyo, Japan, and Microsoft).

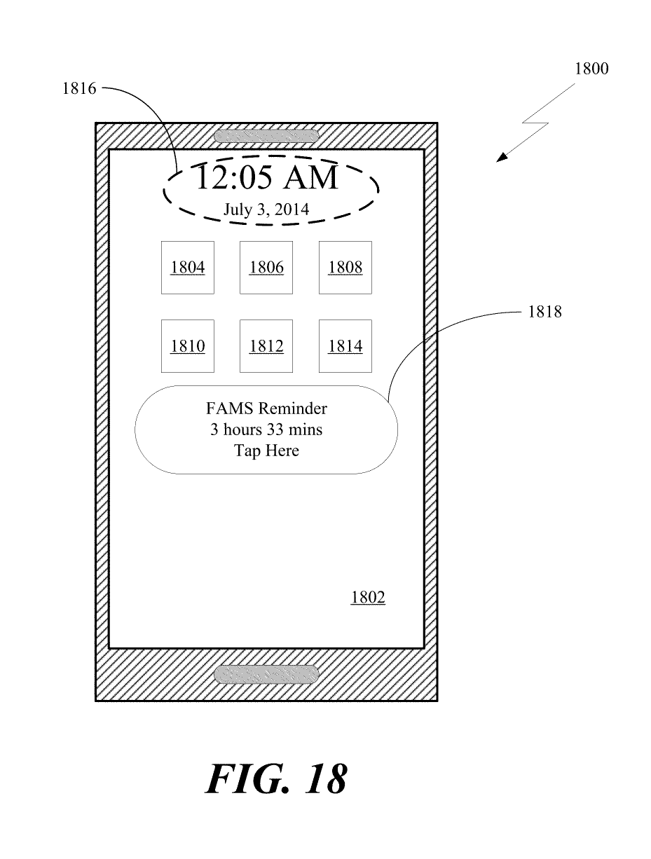

Turning to FIG. 18, a front view of a mobile device 1800 is shown. The mobile device 1800 may be a smart cellular telephone or tablet. The mobile device 1800 includes a display screen 1802 that may include a plurality of icons 1804, 1806, 1808, 1810, 1812, and 1814. The mobile device 1800 may also optionally display 1816 the current time and date on the display screen 1802. The plurality of icons may be icons for different application that may include programs for a music player, video player, camera, video recorder, calendar, email, game, etc. In this example, icon 1804 will be assumed to be an icon for the MobileApp that allows the mobile device 1800 to communicate with the MIFAS 656.

In the case of an NSF event, a window or other graphical warning display 1818 may be displayed on the display screen 1802. The graphical warning display 1818 may state something such as, for example, “FAMS Reminder, 3 hours 33 mins, Tap Here.” This graphical warning display 1818 would visually give the Payor (the owner of the mobile device 1800) the warning needed that an NSF event has occurred by stating “FAMS Reminder” (where “FAMS” may be replaced with the actual name of the organization sending the message to which the Payor is a customer of) and the time deadline for resolving the issue (in this example 3 hours and 33 minutes). The graphical warning display 1818 may be a pop-up such as, for example, a countdown clock or countdown icon which shows the approaching event deadline (i.e., the FAMS predetermined time period). This graphical warning display 1818 may have a color scheme that stands out on the display screen 1802. Additionally, the MobileApp may also be configured to take control of certain aspects of the mobile device 1800 such that it appears on a lockout screen or locks the mobile device 1800 in a way the requires the Payor to actively respond to the alert provided by the MobileApp.

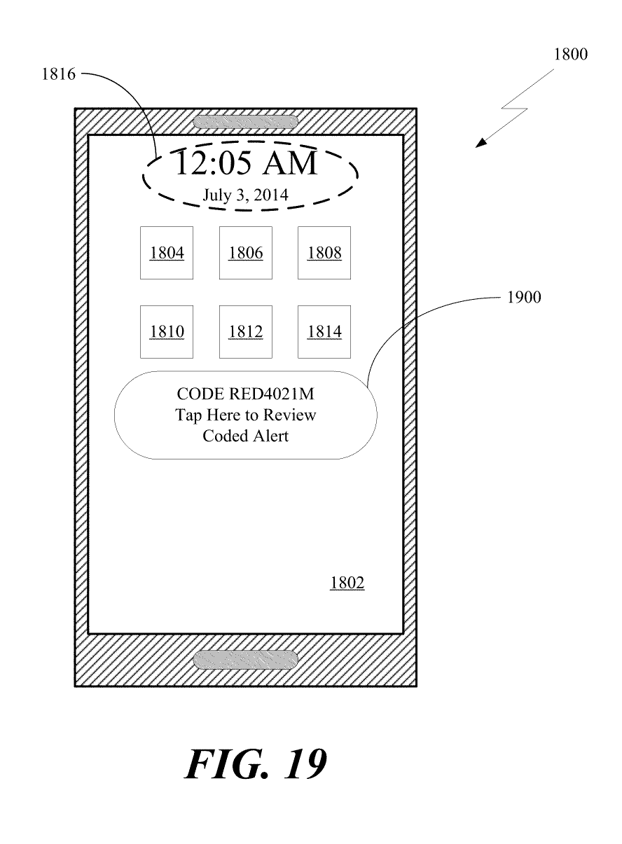

If the Payor desires or the FAMS 600 requires more privacy, the graphical warning display 1900 may be changed to a code message (as shown in FIG. 19) that states, for example, “CODE RED4021M, Tap Here to Review, Coded Alert.” In this example, the “RED4021M” may be a UIC. In both situations, the Payor is provided with a visual warning that an NSF event has occurred and a way to access their account to attempt to resolve the problem.

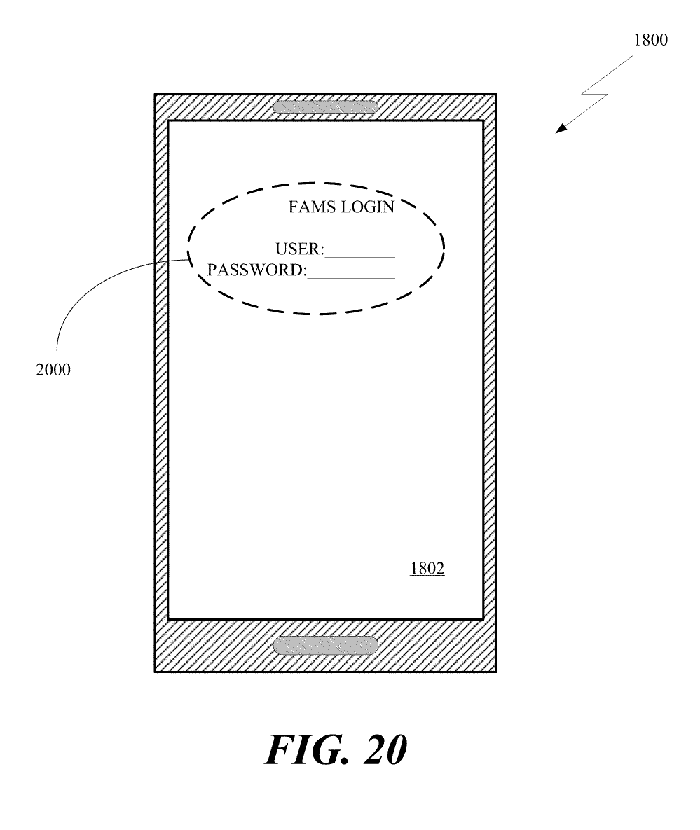

In FIG. 20, a front view of a mobile device 1800 is shown with a login screen 2000. The login screen 2000 includes fields for the Payor to enter a user identification and password. Alternatively, the Payor may optionally set the MobileApp to auto login to the MobileApp without having to actually go through login screen 2000.

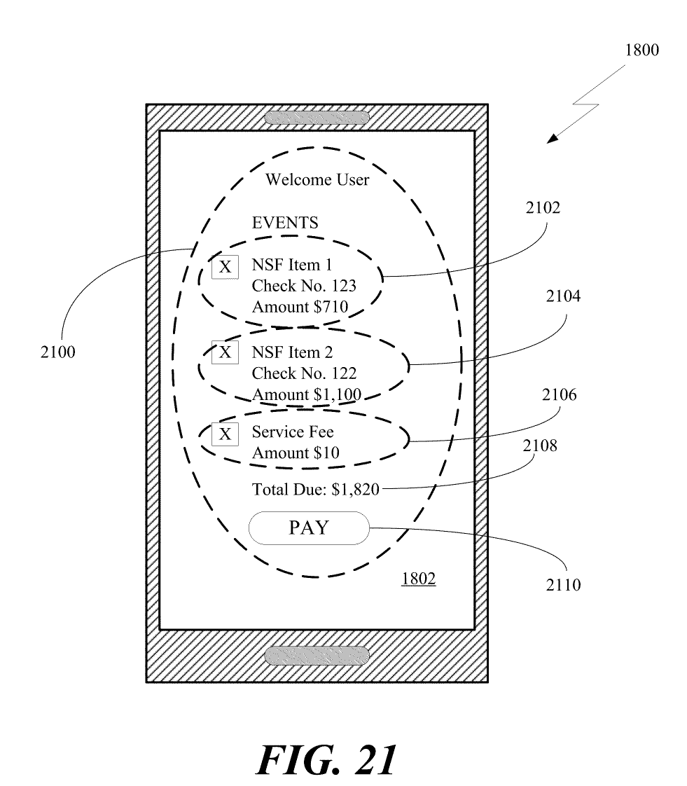

Once logged in, the mobile device 1800 may display an Events screen 2100 on the display screen 1802 as shown in FIG. 21. The Events screen 2100 will display the NSF events corresponding to those reported to the FAMS 600. On the Events screen 2100, the Payor may have access to specific NSF events and fees. As an example, event one 2102 is “NSF item 1, Check No. 123 in the amount of $710.” Event two 2104 is “NSF item 2, Check No. 122 in the amount of $1,100” and event three 2106 is “Service Fee of $10,” where the $10 is purely an example amount. The Payor may then select the items (shown as an “x” in the boxes) to pay and the total amount to pay may be displayed 2108. A separate “Pay” button 2110 may be displayed which the Payor can select.

An additional aspect of the MobileApp may include a requirement for the Payor to affirmatively act in order to end the MobileApp reminders. Specifically, in this example, if the Payor chooses not to pay one, or both, of the NSF items 2102 and 2104, the MobileApp may require the Payor to affirmatively respond to the MobileApp that he/she does not want to pay one, or both, of the NSF items 2102 and 2104. As an example, if the Payor selects the first NSF item 2102 for $710 but does not select the second NSF item 2104 for $1,100, the MobileApp may pop-up another screen (not shown) or graphical display that will ask the Payor to confirm that they are not going to pay the second NSF item 2104 for $1,100. Once the Payor confirms the selection, the MobileApp informs the FAMS 600 that the Payor will not pay the second NSF item 2104. The FAMS 600 creates a record of the Payor's choice that may be used by the FAMS 600 in reporting to the FI that sent the NSF events to the FAMS 600, in generating a MOGA score, or in determining other financial decisions such as, for example, the FI offering an overdraft loan to the Payor.

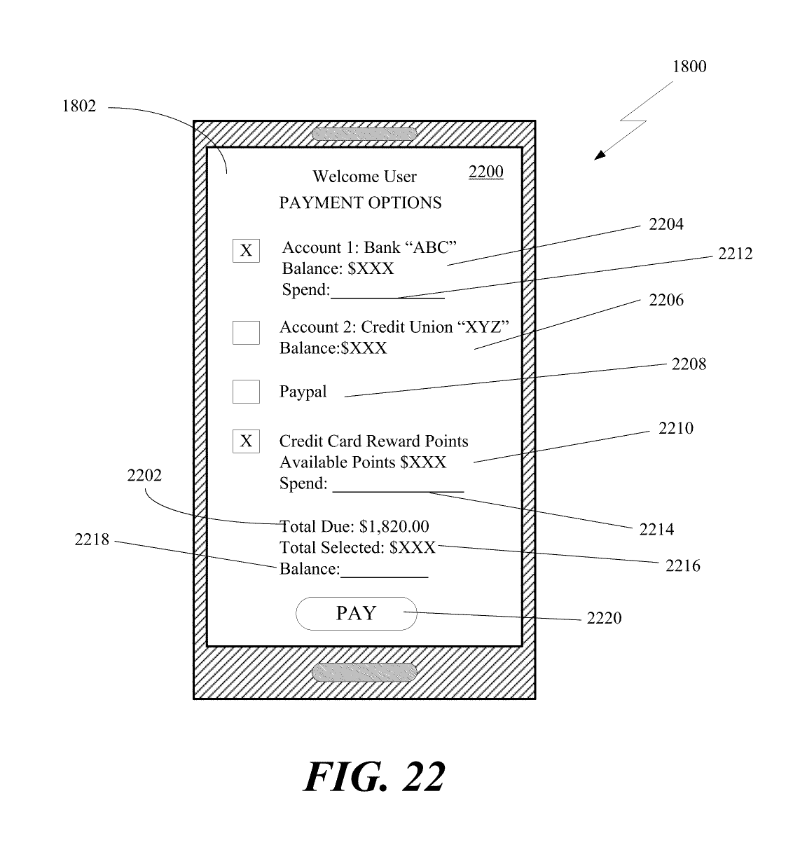

Once the events to be paid are selected the mobile device 1800 can display a “Payment Options” screen 2200 to the Payor in FIG. 22. The total amount of money selected to pay with respect to the NSF events and fees 2202 is displayed. A series of linked Payor accounts or other funding sources may also be displayed. As an example, an account 2204 at a bank “ABC” (having a balance of $XXX), an account 2206 at a credit union “XYZ” (having a balance of $XXX), a Paypal® account 2208, and a credit card reward points account 2210 (having available points worth $XXX) may be displayed. In this example, the Payor has selected the first account 2204 and credit card reward point 2210 options. Since these options have been selected, a spend field is shown 2212 for the first account 2204 and second spend field 2214 is shown for the credit card reward selection 2210. The spend fields are interactive fields that may up to allow the Payor to enter an amount of the balance to use. The total amount selected by the Payor is shown as the “total selected” field 2216. Any difference between the total due 2202 and the total selected 2216 is shown as a “balance” 2218. The MIFAS 656 may optionally set limits to what the balance 2218 may be before allowing a payment to be made by the Payor. As an example, the FAMS 600 may require a minimum payment that is related to the values of the individual or combined NSF events. Once all the amounts are properly selected an entered, the Payor may send the funds by selecting the Pay button 2220.

Alternatively, assuming the Payor does not have his accounts liked through the MobileApp, the MobileApp may provide the Payor with directions to the nearest FAMS associated business entities that will receive in person payment from the Payor.

In addition to the above mentioned activities, the MobileApp may also be utilized by the FAMS 600 to help the Payor in obtaining potential financing for paying the NSF event(s) from the FI, FAMS organization, and/or independent third-party financers. Turning back to FIG. 22, the payment option screen 2200 may also include an option to link (not shown) the Payor to an FI overdraft account application, FAMS organization based loan application, financial pools and/or other entities that may fund the NSF payment(s). This link may include a robot function that provides the Payor with a way of providing information that may include NSF amount(s) owed, credit score, asset statement, profit and loss statement, check system record, MOGA score, clearance against fraud by the DFAS, and qualification for a secured and/or unsecured loan. The robot function may then submit the Payor application to fund the NSF costs to potential funding sources and then collects any offers from these potential funding sources and provides the application/customer terms to the Payor to consider. The robot function may be performed by the MobileApp, MIFAS, and/or FAMS. In this way, the FAMS may be configured to help the Payor via a time extension to pay the NSF event and/or gap funding when the Payor is unable to fund the account before the expiration of the FAMS predetermined time period. In this example, the Payor is offered or requests help from FAMS. In response, FAMS, in some instances, via contact with the FIs is able to extend the FI's predetermined time period to fund the account before returning the NSF item to the Payor. In other instances, FAMS does, or directs the Payor to a third-party who can provide a gap financing to fund the Payor to avoid a return of the NSF item. In this example, a credit metric that includes the MOGA score for the Payor may be utilized to determine if the Payor is a good risk for gap funding. If gap funding is obtained, FAMS may charge the Payor for the service.

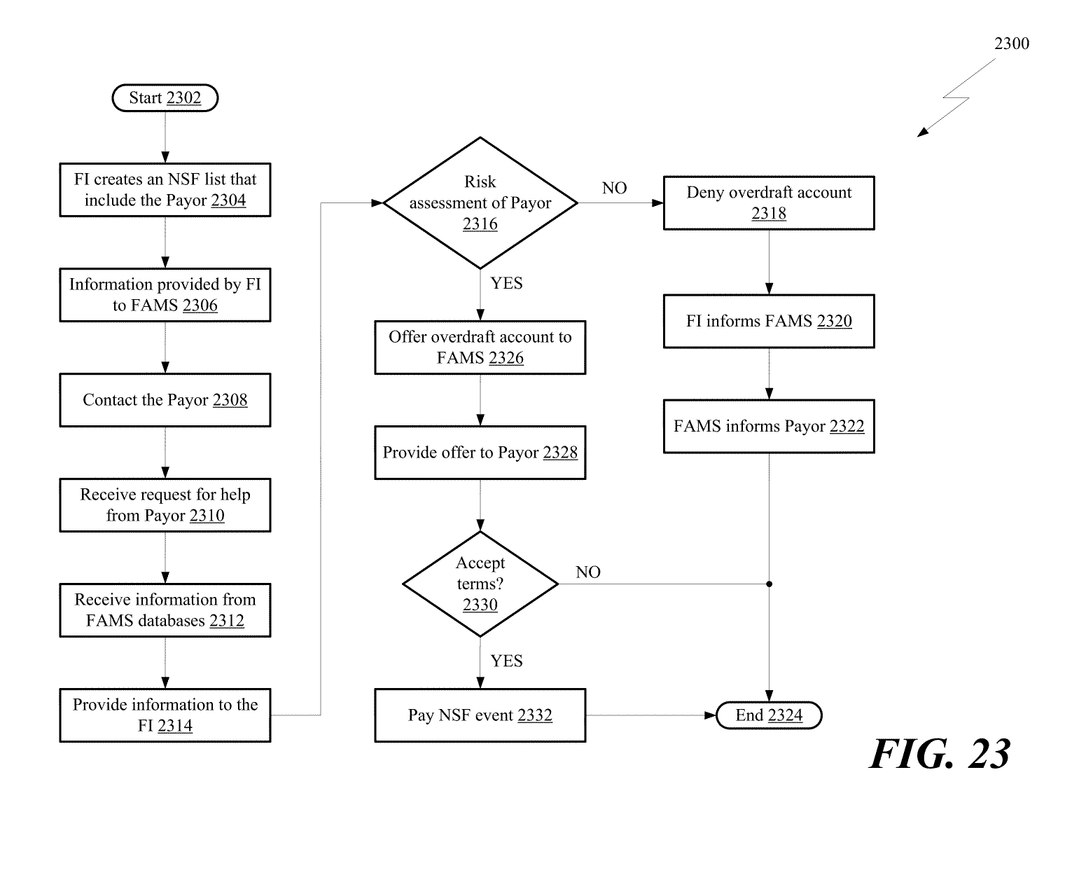

Turning to FIG. 23, a flowchart 2300 is shown of a process that describes a potential offer for an overdraft account (“ODA”) from the FI of the Payor to the Payor to pay an NSF event(s). The process starts 2302 when the Payor causes an NSF event and the FI of the Payor creates a corresponding NSF list that includes the Payor's NSF event 2304. This NSF list is passed to the FAMS 2306 and FAMS attempts to contact the Payor 2308. If the Payor sends FAMS a request for help in extending or paying the NSF item 2310, FAMS retrieves information about the Payor from its database(s) 2312 the may include a MOGA score for the Payor and passed it to the FI 2314. The FI then may perform a risk assessment 2316 for the Payor to determine if a loan (such as, for example, an overdraft account) is offered to the Payor. If the FI denies the loan 2318, the FI informs FAMS 2320 that the loan has been denied and then FAMS correspondingly informs 2322 the Payor. The process then ends 2324.

Alternatively, if the FI approves the loan, the offer of a loan is passed to the FAMS 2326 and the FAMS correspondingly passes the offer to the Payor 2328. If the Payor does not accept the terms of the offer in decision step 2330, the process ends 2324. If, alternatively, the Payor does accept the terms of the offer, the FAMS informs the FI of the Payors acceptance and the FI funds the payment of the NSF event(s) 2332. The process then ends 2324.

A similar software GUI may be utilized by non-mobile devices via an Internet interface or locally installed software on non-mobile computers, smart televisions, digital media players, or gaming consoles.

It is appreciated that the MobileApp may also provide the Payor with additional information beyond just NSF events. Specifically, if the Payor is a customer of the FAMS organization, the FAMS organization may also provide the Payor with fraud alert warnings from the DFAS 1100 and the MOGA scores from the MOGA 1500. This additionally information may also be supplied to customers the use non-mobile computers, smart televisions, digital media players, or gaming consoles.

It will be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

What is claimed is:

1. A Financial Alert Management System (“FAMS”) for reducing the occurrence of a non-payment event, at a first financial institution (“1^{st} FI”), of a negotiable instrument listing a monetary amount, wherein the negotiable instrument was generated by a Payor having a Payor account at the 1^{st} FI, wherein the negotiable instrument has caused a non-sufficient funds (“NSF”) occurrence because the monetary amount of the negotiable instrument exceeds an available funds amount in the Payor account, wherein an overdraft, which is actually drawn on the Payor account, is an NSF occurrence that results in the available funds amount becoming negative, wherein the 1^{st} FI has produced an NSF list that includes the NSF occurrence as an NSF item within the NSF list, wherein the 1^{st} FI has produced a Payor contact list that includes contact information for the Payor, and wherein the 1^{st} FI determines an FI predetermined time period for receiving funds to cover the NSF occurrence before the non-payment event occurs where the 1^{st} FI refuses to pay the negotiable instrument, the FAMS comprising:
a first communication module;
a database;
a timing module;
a second communication module;
a payment module,
a mobile interface for financial alert system (“MIFAS”); and
a controller in signal communication with the first communication module, the second communication module, the payment module, the timing module, and the database,
wherein the controller is configured to control the operation of the FAMS,
wherein the first communication module is configured to receive the NSF list, the Payor contact list, and the FI predetermined time period from the 1^{st} FI,
wherein the database is configured to store the NSF items from the NSF list and the contact information for the Payor from the Payor contact list,
wherein the stored NSF items are not overdrafts,
wherein the timing module is configured to generate a FAMS predetermined time period based on the FI predetermined time period,
wherein the second communication module is configured to attempt communication with the Payor based on the contact information for the Payor and, if successful, communicate to the Payor the NSF occurrence, the need to pay at least the amount necessary to cure the NSF occurrence, and the FAMS predetermined time period,
wherein the payment module is configured to receive a payment from the Payor,
wherein the first communication module is further configured to send a payment notice to the 1^{st} FI such that the 1^{st} FI does not refuse to pay the negotiable instrument, and
wherein the MIFAS is in signal communication with a mobile device.

2. The FAMS of claim 1, wherein MIFAS is in signal communication with a mobile application (“MobileApp”) installed on the mobile device.

3. The FAMS of claim 1, wherein the MIFAS is in signal communication with a non-mobile device chosen from the group consisting of non-mobile computers, smart televisions, digital media players, and gaming consoles.

4. The FAMS of claim 1, further including a unique identifier code (“UIC”) generator, wherein the UIC generator is configured to assign a UIC to uniquely identify the NSF item corresponding to the Payor.

5. The FAMS of claim 4, wherein the UIC generator is configured to assign a UIC to uniquely identify a plurality of NSF items corresponding to the Payor.

6. The FAMS of claim 1, further including a coded message generator (“CMG”), wherein the CMG is configured to generate a coded message to the Payor for privacy.

7. The FAMS of claim 6, wherein the CMG is configured to generate the coded message utilizing a safe word or password.

8. The FAMS of claim 1, wherein the database includes a database of NSF items and a database of Payors.

9. The FAMS of claim 1, wherein the payment module is configured to receive the payment from the Payor within the FAMS predetermined time period.

10. The FAMS of claim 9,
wherein the second communication module is configured to attempt communication with a third-party designee (“3^{rd} Party Designee”) of the Payor based on the contact information for the Payor and, if successful, communicate to the 3^{rd} Party Designee the NSF occurrence, the need to pay at least the amount necessary to cure the NSF occurrence, and the FAMS predetermined time period,
wherein the payment module is configured to receive a payment from the 3^{rd} Party Designee, and
wherein the payment module is configured to receive the payment from the 3^{rd} Party Designee within the FAMS predetermined time period.

11. The FAMS of claim 10,
wherein the second communication module is configured to attempt communication with either the Payor or 3^{rd} Party Designee via machine generated telephone message, prerecorded telephone message, mobile textual message, and email, and
wherein MIFAS is in signal communication with a mobile application (“MobileApp”) installed on the mobile device and is configured to attempt communication with either the Payor or 3^{rd} Party Designee via the MobileApp.

12. The FAMS of claim 10, wherein the payment module is configured to a receive non-cash payment.

13. The FAMS of claim 11, wherein the payment module is configured to receive the payment at a location that is not the location of the 1^{st} FI.

14. A method for reducing the occurrence of a non-payment event, at a first financial institution (“1^{st} FI”), of a negotiable instrument listing a monetary amount, wherein the negotiable instrument was generated by a Payor having a Payor account at the 1^{st} FI, with a Financial Alert Management System (“FAMS”), wherein the negotiable instrument has caused a non-sufficient funds (“NSF”) occurrence because the monetary amount of the negotiable instrument exceeds an available funds amount in the Payor account, wherein the NSF occurrence is an overdraft NSF occurrence if the negotiable instrument is actually drawn on the Payor account and as a result causes the available funds amount to become negative, wherein the 1^{st} FI has produced a NSF list that includes the NSF occurrence as an NSF item within the NSF list, wherein the 1^{st} FI has produced a Payor contact list that includes contact information for Payor, and wherein the 1^{st} FI determines an FI predetermined time period for receiving funds to cover the NSF occurrence before the non-payment event where the 1^{st} FI refuses to pay the negotiable instrument, the method comprising:
receiving the NSF list, the Payor contract list, and the FI predetermined time period from the 1^{st} FI at the FAMS;
storing the NSF items from the NSF list at the FAMS, wherein the stored NSF items are not overdraft NSF occurrences;
storing the contact information for the Payor from the Payor contact list at the FAMS;
generating a FAMS predetermined time period based on the FI predetermined time period;
attempting communication with the Payor based on the contact information for a mobile device of the Payor; and
if successful, communicating to the Payor the NSF occurrence, the need to pay at least the amount necessary to cure the NSF occurrence, and the FAMS predetermined time period.

15. The method of claim 14, where the method further includes
in response to the communication to the Payor, receiving a payment from the Payor within the FAM predetermined time period, and
sending a payment notice to the 1^{st} FI such that the 1^{st} FI does not refuse to pay the negotiable instrument.

16. The method of claim 12, where the method further includes the step of sending a non-payment notice to the 1^{st} FI where a payment was not received from the Payor within the FAM predetermined time period.

17. A Financial Alert Management System (“FAMS”) for reducing the occurrence of a non-payment event, at a first financial institution (“1^{st} FI), of a negotiable instrument listing a monetary amount, wherein the negotiable instrument was generated by a Payor having a Payor account at the 1^{st} FI, wherein the negotiable instrument has caused a non-sufficient funds (“NSF”) occurrence because the monetary amount of the negotiable instrument exceeds an available funds amount in the Payor account, wherein the NSF occurrence is an overdraft NSF occurrence if the negotiable instrument is actually drawn on the Payor account and as a result causes the available funds amount to become negative, wherein the 1^{st} FI has produced an NSF list that includes the NSF occurrence as an NSF item within the NSF list, wherein the 1^{st} FI has produced a Payor contact list that includes contact information for the Payor, and wherein the 1^{st} FI determines an FI predetermined time period for receiving funds to cover the NSF occurrence before the non-payment event occurs where the 1^{st} FI refuses to pay the negotiable instrument, the FAMS comprising:
means for receiving the NSF list, the Payor contract list, and the FI predetermined time period from the 1^{st} FI at the FAMS;
means for storing the NSF items from the NSF list at the FAMS, wherein the stored NSF items are not overdraft NSF occurrences;
means for storing the contact information for the Payor from the Payor contact list at the FAMS;
means for generating a FAMS predetermined time period based on the FI predetermined time period;
means for attempting communication with the Payor based on the contact information for a mobile device of the Payor;
if successful, means for communicating to the Payor the NSF occurrence, the need to pay at least the amount necessary to cure the NSF occurrence, and the FAMS predetermined time period.

18. The FAMS of claim 17, further including
in response to the communication to the Payor, means for receiving a payment from the Payor within the FAM predetermined time period, and
means for sending a payment notice to the 1^{st} FI such that the 1^{st} FI does not refuse to pay the negotiable instrument.

19. The FAMS of claim 18, further including means for sending a non-payment notice to the 1^{st} FI where a payment was not received from the Payor within the FAM predetermined time period.

20. The FAMS of claim 17, further including
in response to the communication to the Payor, means for receiving a payment from a third party within the FAM predetermined time period, and
means for sending a payment notice to the 1^{st} FI such that the 1^{st} FI does not refuse to pay the negotiable instrument.

21. The FAMS of claim 20, further including means for sending a non-payment notice to the 1^{st} FI where a payment was not received from the Payor within the FAM predetermined time period.
